(19) United States
(12) Patent Application Publication
(10) Pub. No.: US 2020/0337114 A1
(43) Pub. Date: Oct. 22, 2020

(54) COMMUNICATION CONTROL METHOD AND INFORMATION PROCESSING APPARATUS

(71) Applicant: FUJITSU LIMITED, Kawasaki-shi (JP)

(72) Inventor: Masahiro Miwa, Kawaguchi (JP)

(73) Assignee: FUJITSU LIMITED, Kawasaki-shi (JP)

(21) Appl. No.: 16/830,655

(22) Filed: Mar. 26, 2020

(30) Foreign Application Priority Data
Apr. 16, 2019 (JP) 2019-077727

(51) Int. Cl. H04W 88/04; H04B 7/26; H04W 84/04; H04W 40/22; H04W 84/18; H04L 27/26

(52) U.S. Cl. CPC H04W 88/04; H04B 7/2606; H04L 27/2607; H04W 40/22; H04W 84/18; H04W 84/047

(57) ABSTRACT

In a system including a plurality of nodes, a plurality of first relay devices, and a plurality of second relay devices, where each first relay device is connected to two or more second relay devices, the nodes are classified into a plurality of groups such that different nodes individually connected to different first relay devices having different sets of second relay devices connected thereto are classified into different groups. A representative node is selected from each group. Communication order of first internode communication performed between the representative nodes is determined such that data is transferred according to a first tree, in parallel with which different data is transferred according to a second tree. Communication order of second internode communication performed for each group is determined such that data is transferred according to a third tree, in parallel with which different data is transferred according to a fourth tree.

### CROSS-REFERENCE TO RELATED APPLICATION

This application is based upon and claims the benefit of priority of the prior Japanese Patent Application No. 2019-077727, filed on Apr. 16, 2019, the entire contents of which are incorporated herein by reference.

### FIELD

The embodiments discussed herein are related to a communication control method and information processing apparatus.

### BACKGROUND

There are parallel processing systems including a plurality of information processing apparatuses as nodes. The parallel processing systems assign a plurality of processes belonging to the same job to the multiple nodes, which then run the assigned processes in parallel. During the job, communication may take place between the nodes. User programs establishing internode communication are sometimes implemented using a communication library such as Message Passing Interface (MPI). As internode communication, collective communication (also termed group communication) is known, in which a plurality of nodes engaged in a job simultaneously participates in data transmission. There are various collective communication routines including ‘reduce’ in which pieces of data dispersed in a plurality of different nodes are transferred to a single node; and ‘broadcast’ in which the same data is copied from a single node to a plurality of different nodes.

Note that in the case where a parallel processing system includes a large number of nodes, it is difficult to connect all the nodes directly to a single relay device, such as a single switch. Therefore, what is important is a network topology (sometimes simply termed topology) which represents the interconnection between a plurality of nodes and a plurality of relay devices. Communication between a single node and another node may be realized via two or more relay devices. In some cases, the selection of a topology for a parallel processing system takes into account redundancy in internode communication paths and cost dependent, for example, on the number of replay devices.

A multi-layer full mesh system with a multi-layer full mesh topology has been proposed as one type of parallel processing system. The proposed multi-layer full mesh system includes a plurality of nodes, a plurality of leaf switches, and a plurality of spine switches, and forms a plurality of layers. Each node is connected to one of the leaf switches, each of which belongs to one of the layers, and each spine switch penetrates the multiple layers.

In each layer, two or more leaf switches are connected to each other in a full mesh topology. For every pair of leaf switches, there is a communication path not running through a different leaf switch. Note however that, for every pair of leaf switches, a single spine switch is provided therebetween. Therefore, within each layer, a single leaf switch communicates with a different leaf switch via a spine switch, which connects the multiple layers. Hence, the single leaf switch is also able to communicate with a leaf switch belonging to a different layer via the spine switch.

There is another proposed technique related to a parallel computer including a plurality of nodes connected in a tree structure. The proposed parallel computer realizes a broadcast operation by copying a piece of data downstream, from a single node at the root of the tree toward a plurality of terminal nodes. The parallel computer also realizes a reduce operation by transferring data pieces upstream, from the terminal nodes of the tree toward the single root node.

See, for example, the following documents:

International Publication Pamphlet No. WO 2002/069168; and

Japanese Laid-open Patent Publication No. 2018-185650.

As algorithms for collective communication, tree algorithms are known which decide communication peers for individual nodes such that the communication order among a plurality of nodes is structured into a tree. With a tree algorithm, a reduce operation is implemented by transferring data along a tree from leaves of the tree to its root as, for example, that Processes 1 and 3 transfer data to Process 2, Processes 5 and 7 transfer data to Process 6, and Processes 2 and 6 transfer data to Process 4. In addition, a broadcast operation is implemented by transferring data along the tree from the root to the leaves as, for example, that Process 4 copies data to Processes 2 and 6, Process 2 copies data to Processes 1 and 3, and Process 6 copies data to Processes 5 and 7.

Note however that implementation of collective communication based on a single tree is likely to cause idle time on each node during which at least one of data transmission and reception is not performed, possibly resulting in underuse of the communication band of links. In view of this, two-tree algorithms have been proposed as collective communication algorithms. According to the two-tree algorithms, a data set is divided into two subsets, and two trees are generated, each representing different communication order among a plurality of nodes. Then, one of the two subsets is consolidated or copied according to one of the two trees while the other subset is consolidated or copied according to the other tree. This improves link utilization during collective communication, thereby reducing communication time.

However, there remains a problem that some topologies for parallel processing systems have an increased chance of causing communication conflicts when communication based on a plurality of trees is carried out in parallel. In the case where Process 2 transfers data to Process 4 according to one of the trees, in parallel with which Process 3 transfers data to Process 5 according to the other tree, a communication conflict may arise if the two communication paths use the same link. The communication conflict results in communication delay due to, for example, queued packets waiting for transmission and division of the communication band of one link, thus increasing communication time.

For example, in the aforementioned multi-layer full mesh system, the number of shortest paths between two leaf switches corresponds to the number of spine switches commonly connected to the two leaf switches. Only one shortest path exists between two leaf switches belonging to the same layer. Therefore, in the case where Processes 2 and 3 are under one leaf switch while Processes 4 and 5 are under a different leaf switch, communication from Process 2 to Process 4 may conflict with communication from Process 3 to Process 5.

### SUMMARY

According to one embodiment, there is provided a non-transitory computer-readable recording medium storing therein a computer program that causes a computer to execute a process including classifying, in a system including a plurality of nodes, a plurality of first relay devices, and a plurality of second relay devices, where each of the plurality of nodes is connected to one of the plurality of first relay devices and each of the plurality of first relay devices is connected to two or more second relay devices from among the plurality of second relay devices, the plurality of nodes into a plurality of groups such that different nodes individually connected to different first relay devices having different sets of the two or more second relay devices connected thereto are classified into different groups; selecting a representative node from each of the plurality of groups; determining communication order of first internode communication performed between the representative nodes corresponding to the plurality of groups such that, with one of the representative nodes serving as a base point, a first transfer process is performed, where remaining representative nodes other than the one of the representative nodes transfer data according to a first tree, in parallel with which a second transfer process is performed, where the remaining representative nodes transfer, according to a second tree, data different from the data transferred in the first transfer process; and determining, with respect to each of the plurality of groups, communication order of second internode communication performed between two or more nodes included in the each of the plurality of groups before or after the first internode communication such that, with the representative node of the each of the plurality of groups serving as a base point, a third transfer process is performed, where remaining nodes other than the representative node transfer data according to a third tree, in parallel with which a fourth transfer process is performed, where the remaining nodes transfer, according to a fourth tree, data different from the data transferred in the third transfer process.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates an exemplary information processing system according to a first embodiment;

FIG. 2 illustrates an exemplary multi-layer full mesh system according to a second embodiment;

FIG. 3 illustrates exemplary wiring of the multi-layer full mesh system;

FIG. 4 is a block diagram illustrating an exemplary hardware configuration of a server;

FIG. 5 is a block diagram illustrating an exemplary hardware configuration of a switch;

FIG. 6 illustrates an exemplary tree algorithm;

FIG. 7 illustrates an exemplary transmission and reception relationship in a reduce operation based on a tree;

FIG. 8 illustrates an exemplary two-tree algorithm;

FIG. 9 illustrates an exemplary transmission and reception relationship in a reduce operation based on a two tree;

FIG. 10 illustrates a first example of process assignment;

FIG. 11 illustrates exemplary two-tree generation;

FIG. 12 illustrates an exemplary conflict in the reduce operation;

FIG. 13 illustrates a second example of process assignment;

FIG. 14 illustrates exemplary local two-tree generation;

FIG. 15 illustrates exemplary global two-tree generation;

FIG. 16 illustrates exemplary functional components of a server and a job scheduler;

FIG. 17 illustrates exemplary communication procedure tables;

FIG. 18 is a flowchart illustrating an exemplary process for determining a communication procedure; and

FIG. 19 is a flowchart illustrating an exemplary process for collective communication.

### DESCRIPTION OF EMBODIMENTS

Several embodiments will be described below with reference to the accompanying drawings.

### (a) First Embodiment

A first embodiment is described hereinafter.

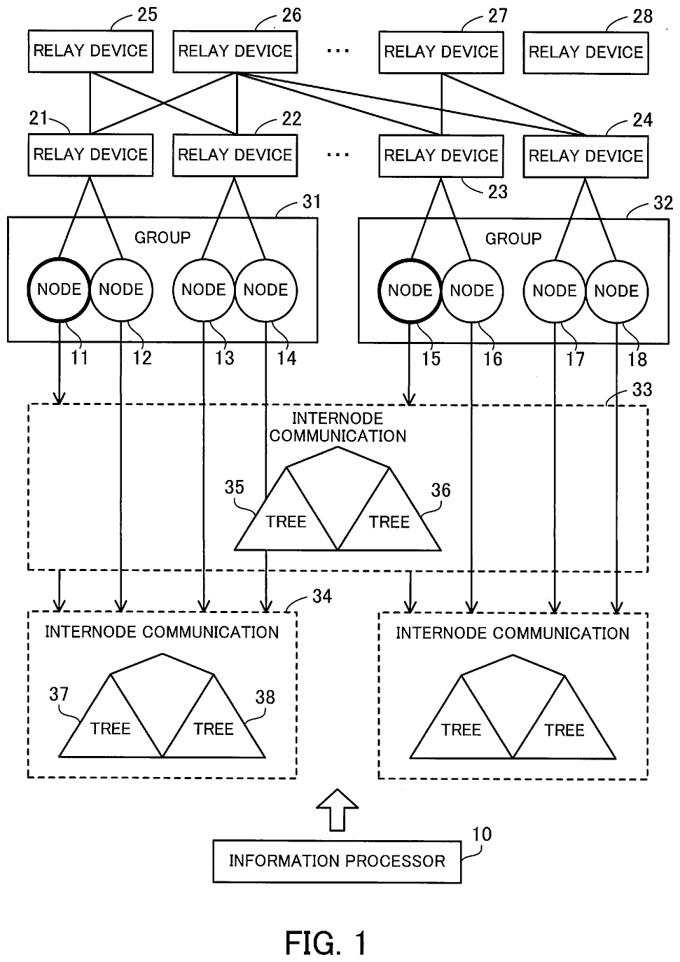

FIG. 1 illustrates an exemplary information processing system according to the first embodiment.

The information processing system according to the first embodiment controls internode communication among a plurality of nodes conducting information processing in parallel. The internode communication here may be collective communication or group communication. Collective communication routines include a reduce operation in which pieces of data dispersedly stored in a plurality of nodes are transferred, and then consolidated and gathered in one node; and a broadcast operation in which data stored in a single node is copied and distributed to a plurality of nodes. The system here concerned (referred to hereinafter as the “target system”), conducting internode communication, is, for example, a multi-layer full mesh system with a multi-layer full mesh topology. Note however that the target system is not limited to a multi-layer full mesh system if it has a configuration described below.

The information processing system of the first embodiment includes an information processor 10. The information processor 10 may be a control device such as a job scheduler for controlling the target system which performs internode communication, or one of the nodes included in the target system.

The information processor 10 includes a storing unit and a processing unit. The storing unit may be volatile memory such as random access memory (RAM), or a non-volatile storage device such as a hard disk drive (HDD) or flash memory. The processing unit is, for example, a processor such as a central processing unit (CPU), graphics processing unit (GPU), or digital signal processor (DSP). Note however that, the processing unit may include an electronic circuit designed for specific use, such as an application specific integrated circuit (ASIC) or a field programmable gate array (FPGA). The processor executes programs stored in memory. The term “multiprocessor”, or simply “processor”, may be used to refer to a set of multiple processors.

The target system conducting internode communication has a plurality of nodes including nodes 11, 12, 13, 14, 15, 16, 17, and 18. The target system also has a plurality of relay devices including relay devices 21, 22, 23, 24, 25, 26, 27, and 28. The relay devices 21, 22, 23, and 24 are lower-level relay devices (first relay devices). The relay devices 25, 26, 27, and 28 are higher-level relay devices (second relay devices). The relay devices 21, 22, 23, 24, 25, 26, 27, and 28 transfer data according to their connection relationship.

Each of the multiple nodes is connected to one of the multiple first relay devices. Each of the first relay devices is connected to two or more second relay devices amongst the multiple second relay devices. In the example of FIG. 1, the nodes 11 and 12 are connected to the relay device 21, the nodes 13 and 14 are connected to the relay device 22, the nodes 15 and 16 are connected to the relay device 23, and the nodes 17 and 18 are connected to the relay device 24. The relay device 21 is connected to the relay devices 25 and 26, the relay device 22 is connected to the relay devices 25 and 26, the relay device 23 is connected to the relay devices 26 and 27, and the relay device 24 is connected to the relay devices 26 and 27.

In regard to internode communication run on the target system, the information processor 10 determines communication order among the multiple nodes. The internode communication is carried out, for example, in a plurality of phases. During one phase, two or more nodes may transmit data in parallel. In determining the internode communication order, for example, which nodes act as sender nodes in each phase are determined.

First, the information processor 10 classifies the multiple nodes included in the target system into a plurality of groups. At this time, the information processor 1C classifies the multiple first relay devices into a plurality of groups based on the sameness of two or more second relay devices connected to each of the first relay devices. The grouping is done such that first relay devices having different sets of two or more second relay devices connected thereto are split into different groups. For example, first relay devices with the same combination of two or more second relay devices connected thereto are put into the same group. Then, the information processor 10 determines nodes connected to first relay devices put into one group as nodes belonging to the group. Each node belongs to one of the groups.

In the example of FIG. 1, both the relay devices 21 and 22 are individually connected to the higher-level relay devices 25 and 26. Similarly, both the relay devices 23 and 24 are individually connected to the higher-level relay devices 26 and 27. In this case, the relay devices 21 and 22 may be put into the same group. Similarly, the relay devices 23 and 24 may be put into the same group. On the other hand, the relay device 21 and the relay devices 23 and 24 are separated into different groups. In addition, the relay device 22 and the relay devices 23 and 24 are separated into different groups.

In this example, the information processor 10 classifies the nodes 11 and 12 connected to the relay device 21 and the nodes 13 and 14 connected to the relay device 22 into a group 31. The information processor 10 also classifies the nodes 15 and 16 connected to the relay device 23 and the nodes 17 and 18 connected to the relay device 24 into a group 32. Note however that it is allowed to put the nodes 11 and 12 and the nodes 13 and 14 into different groups. Similarly, it is allowed to put the nodes 15 and 16 and the nodes 17 and 18 into different groups.

Subsequently, the information processor 10 selects a representative node from each of the created groups. In this regard, simply one node needs to be selected as a representative node from each group, and a selection criterion of some sort may be predefined. For example, the information processor 10 selects, amongst two or more nodes of each group, a node assigned a process having the lowest identification number. In the example of FIG. 1, the information processor 10 selects the node 11 as a representative node from the group 31. In addition, the information processor 10 selects the node 15 as a representative node from the group 32.

Next, the information processor 10 determines communication order of internode communication 33 (first internode communication) conducted among a plurality of representative nodes corresponding to the created groups. In addition, with respect to each of the groups, the information processor 10 determines communication order of internode communication 34 (second internode communication) conducted among the two or more nodes included in the group. The internode communication 33 and the internode communication 34 are individually carried out as part of the whole internode communication while being distinguished from one another as different stages. The internode communication 33 is intergroup communication while the internode communication 34 is intragroup communication. In the internode communication 33, only the single representative node of each group participates in the communication. The internode communication 34 is carried out before or after the internode communication 33. For example, in the case of a reduce operation, the internode communication 34 is conducted before the internode communication 33. In the case of a broadcast operation, on the other hand, the internode communication 34 is conducted after the internode communication 33. The internode communication 34 of the multiple groups may be performed in parallel.

The information processor 10 determines the communication order among the representative nodes corresponding to the multiple groups such that the internode communication 33 satisfies the following conditions. The information processor 10 selects one representative node as a base point, and generates a tree 35 (first tree) and a tree 36 (second tree) each indicating data transfer order among representative nodes other than the base point. The trees 35 and 36 indicate different data transfer order among the representative nodes. The tree 36 is obtained, for example, by cyclic shifting each representative node in the tree 35. The trees 35 and 36 are connected by the base point to form a large tree.

In the internode communication 33, a first transfer process is performed in which the representative nodes other than the base point transfer data according to the tree 35. In parallel with the first transfer process, a second transfer process is performed in which the representative nodes other than the base point transfer, according to the tree 36, data different from that of the first transfer process.

In the case of a reduce operation, a part of data stored in each representative node is transferred along the tree 35 from the leaf side toward the root side, and the other part of the data (for example, data remaining after the first transfer process) stored in each representative node is transferred along the tree 36 from the leaf side toward the root side. Herewith, the data stored in each representative node is consolidated and gathered in the base point. In the case of a broadcast operation, a part of data stored in the base point is transferred from the root of the tree 35 toward its leaves, and the other part of the data stored in the base point is transferred from the root of the tree 36 toward its leaves. Herewith, the data stored in the base point is copied to each representative node. Note that the communication order of the internode communication 33 may be determined based on a two-tree algorithm.

In addition, the information processor 10 determines the communication order among two or more nodes of each group such that the internode communication 34 satisfies the following conditions. The information processor 10 selects, amongst the two or more nodes of the group, the representative node as a base point, and generates a tree 37 (third tree) and a tree 38 (fourth tree) each indicating data transfer order among nodes other than the base point. The trees 37 and 38 indicate different data transfer order among the nodes. The tree 38 is obtained, for example, by cyclic shifting each node in the tree 37. The trees 37 and 38 are connected by the base point to form a large tree.

In the internode communication 34, a third transfer process is performed in which nodes other than the base point transfer data according to the tree 37. In parallel with the third transfer process, a fourth transfer process is performed in which nodes other than the base point transfer, according to the tree 38, data different from that of the third transfer process.

In the case of a reduce operation, a part of data stored in each node is transferred along the tree 37 from the leaf side toward the root side, and the other part of the data (for example, data remaining after the third transfer process) stored in each node is transferred along the tree 38 from the leaf side toward the root side. Herewith, the data stored in each node is consolidated and gathered in the representative node. In the case of a broadcast operation, a part of data stored in the representative node is transferred along the tree 37 from the root side toward the leaf side, and the other part of the data stored in the representative node is transferred along the tree 38 from the root side toward the leaf side. Herewith, the data stored in the representative node is copied to each node. Note that the communication order of the internode communication 34 may be determined based on a two-tree algorithm.

The information processor 10 joins the communication order of the internode communication 33 and that of the internode communication 34 together to determine a communication procedure of the whole internode communication (for example, the whole collective communication). The information processor 10 generates and then stores communication control information indicating the determined communication procedure. If the information processor 10 is one of the nodes, it may perform internode communication by reference to the generated communication control information. If the information processor 10 is a control device, it may distribute the generated communication control information to the nodes.

According to the information processing system of the first embodiment, the nodes are classified into groups such that different nodes individually connected to different lower-level relay devices having different sets of higher-level relay devices connected thereto are separated into different groups, and a representative node is selected for each of the groups. Then, the whole internode communication is performed in two stages, internode communication among the representative nodes and internode communication within each group. In each of these stages, the internode communication order is determined according to an algorithm that transfers different data in parallel based on a plurality of trees each representing different transfer order.

In each of the internode communication among the representative nodes and the internode communication within each group, divided data is transferred in parallel indifferent transfer order. This reduces the idle time of the communication band of links compared to transferring all data based on a single tree. With full use of the communication band of links, it is possible to speed up internode communication such as a reduce operation and a broadcast operation. In addition, in the aforementioned intragroup communication, redundancy in communication paths is provided between the lower-level relay devices and the higher-level relay devices, thereby reducing communication conflicts. As for the aforementioned intergroup communication, because just one node from each group participates in the communication, communication conflicts are restrained even if the redundancy in intergroup communication paths is low. As a result, it is possible to take control of communication conflicts throughout the whole internode communication, which prevents communication delay and thus shortens communication time.

### (b) Second Embodiment

Next described is a second embodiment.

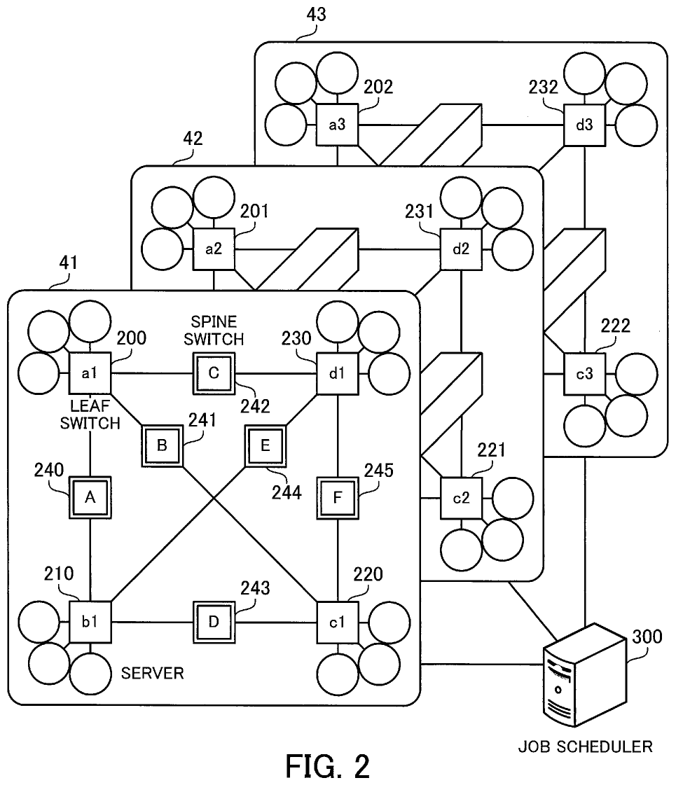

FIG. 2 illustrates an exemplary multi-layer full mesh system according to the second embodiment.

The multi-layer full mesh system according to the second embodiment includes a plurality of servers and a plurality of switches, and forms a parallel processing system in which the multiple servers and switches are connected in a multi-layer full mesh topology. The servers are nodes capable of executing user programs and may be deemed as computers or information processors.

The switches are communication devices for relaying data transmitted between the servers. The switches are classified into leaf switches and spine switches, as described below. The leaf and spine switches may have the same hardware configuration. Assume in the second embodiment that the number of ports on each switch is six for ease of explanation. Note however that the number of ports per switch may be an even number greater than 6, such as 8, 10, or 36.

The multi-layer full mesh system forms a plurality of layers. Each server is connected to one of the leaf switches. Each leaf switch belongs to one of the layers. Each spine switch penetrates the multiple layers and is connected to leaf switches of the multiple layers.

In each layer, a plurality of leaf switches forms a full mesh topology. Therefore, each pair of leaf switches has the shortest path without passing through a different leaf switch. Between every two leaf switches, a spine switch penetrating the multiple layers is provided. Therefore, two leaf switches belonging to the same layer are able to communicate with each other through a communication path via one spine switch. Further, two leaf switches belonging to different layers are also able to communicate with each other through a communication path via one spine switch. Each leaf switch is configured to transfer data over the shortest path according to its destination.

According to the second embodiment where the number of ports is six, the multi-layer full mesh system forms three layers. Each layer includes four leaf switches. To each leaf switch, three servers and three spine switches are connected. To each spine switch, two leaf switches are connected on each layer, and thus six leaf switches in total are connected for all the three layers. The multi-layer full mesh system includes six spine switches.

In general, when switches with the number of ports being p (p is an even number greater than or equal to 6) are used, a multi-layer full mesh system forms p/2 layers. Each layer forms a p/2+1 polygon with p/2+1 leaf switches. The multi-layer full mesh system includes p²(p+2)/8 servers and 3p(p+2)/8 switches. In the case of p=8, the multi-layer full mesh system forms four pentagonal layers and includes 80 servers and 30 switches. In the case of p=10, the multi-layer full mesh system forms five hexagonal layers and includes 150 servers and 45 switches. In the case of p=36, the multi-layer full mesh system forms 18 nonadecagonal (19-gonal) layers and includes 6156 servers and 513 switches.

The multi-layer full mesh system of the second embodiment forms layers 41, 42, and 43. The layer 41 includes leaf switches 200, 210, 220, and 230. Three servers are connected to each of the leaf switches 200, 210, 220, and 230.

Between the leaf switches 200 and 210, a spine switch 240 is provided. Between the leaf switches 200 and 220, a spine switch 241 is provided. Between the leaf switches 200 and 230, a spine switch 242 is provided. Between the leaf switches 210 and 220, a spine switch 243 is provided. Between the leaf switches 210 and 230, a spine switch 244 is provided. Between the leaf switches 220 and 230, a spine switch 245 is provided.

Each of the layers 42 and 43 also includes leaf switches corresponding to the leaf switches 200, 210, 220, and 230. The spine switches 240, 241, 242, 243, 244, and 245 penetrate the layers 41, 42, and 43 and are common among the layers 41, 42, and 43.

For example, the layer 42 includes leaf switches 201, 221, and 231 corresponding to the leaf switches 200, 220, and 230, respectively. On the layer 42, the spine switch 242 is provided between the leaf switches 201 and 231. The spine switch 245 is provided between the leaf switches 221 and 231. The layer 43 includes leaf switches 202, 222, and 232. On the layer 43, the spine switch 242 is provided between the leaf switches 202 and 232. The spine switch 245 is provided between the leaf switches 222 and 232.

The multi-layer full mesh system of the second embodiment also includes a job scheduler 300. The job scheduler 300 is a server device for receiving a job request from the user and selecting servers (nodes) to engage in the job. The job scheduler 300 may be deemed as a computer or information processor. The job includes a plurality of processes run from a user program. The user program may use a communication library such as MPI. The multiple processes are identified using ranks which are non-negative integer identification numbers. One server is assigned one process. The job scheduler 300 determines process allocation and notifies the servers of information on the process allocation.

Communication between the job scheduler 300 and the servers may use a data network including the aforementioned leaf and spine switches, or a management network different from the data network.

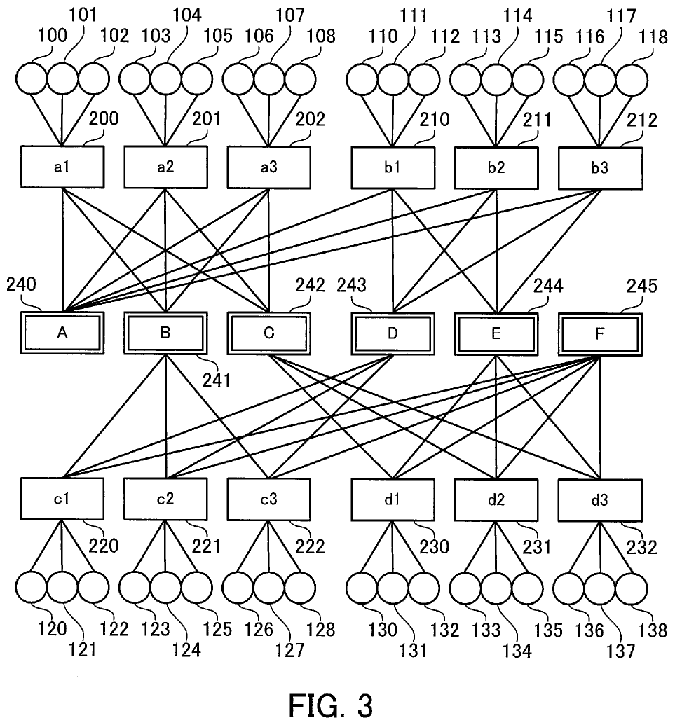

FIG. 3 illustrates exemplary wiring of a multi-layer full mesh system.

FIG. 3 represents wiring between the servers, the leaf switches, and the spine switches included in the multi-layer full mesh system of FIG. 2, in a format different from that illustrated in FIG. 2.

The multi-layer full mesh system includes the spine switches 240, 241, 242, 243, 244, and 245 (Spine Switches A, B, C, D, E, and F).

The multi-layer full mesh system also includes the leaf switches 200, 201, and 202 (Leaf Switches a1, a2, and a3). Each of the leaf switches 200, 201, and 202 is connected to three spine switches, namely the spine switches 240, 241, and 242. To the leaf switch 200, servers 100, 101, and 102 are connected. Similarly, servers 103, 104, and 105 are connected to the leaf switch 201, and servers 106, 107, and 108 are connected to the leaf switch 202.

In addition, the multi-layer full mesh system includes leaf switches 210, 211, and 212 (Leaf Switches b1, b2, and b3). Each of the leaf switches 210, 211, and 212 is connected to three spine switches, namely the spine switches 240, 243, and 244. To the leaf switch 210, servers 110, 111, and 112 are connected. Similarly, servers 113, 114, and 115 are connected to the leaf switch 211, and servers 116, 117, and 118 are connected to the leaf switch 212.

In addition, the multi-layer full mesh system includes leaf switches 220, 221, and 222 (Leaf Switches c1, c2, and c3). Each of the leaf switches 220, 221, and 222 is connected to three spine switches, namely the spine switches 241, 243, and 245. To the leaf switch 220, servers 120, 121, and 122 are connected. Similarly, servers 123, 124, and 125 are connected to the leaf switch 221, and servers 126, 127, and 128 are connected to the leaf switch 222.

Further, the multi-layer full mesh system includes leaf switches 230, 231, and 232 (Leaf Switches d1, d2, and d3). Each of the leaf switches 230, 231, and 232 is connected to three spine switches, namely the spine switches 242, 244, and 245. To the leaf switch 230, servers 130, 131, and 132 are connected. Similarly, servers 133, 134, and 135 are connected to the leaf switch 231, and servers 136, 137, and 138 are connected to the leaf switch 232.

As described above, each leaf switch has, as higher-level switches, three spine switches connected thereto. Leaf switches provided, on the layers 41, 42, and 43, at positions corresponding to each other are connected to the same spine switches. In the second embodiment, leaf switches having the exact same set of three spine switches connected thereto and their subordinate servers are sometimes referred to collectively as an “interlayer group” or simply “group”.

The leaf switches 200, 201, and 202 and their subordinate servers 100, 101, 102, 103, 104, 105, 106, 107, and 108 form one group (Group a). The leaf switches 210, 211, and 212 and their subordinate servers 110, 111, 112, 113, 114, 115, 116, 117, and 118 form one group (Group b). The leaf switches 220, 221, and 222 and their subordinate servers 120, 121, 122, 123, 124, 125, 126, 127, and 128 form one group (Group c). The leaf switches 230, 231, and 232 and their subordinate servers 130, 131, 132, 133, 134, 135, 136, 137, and 138 form one group (Group d).

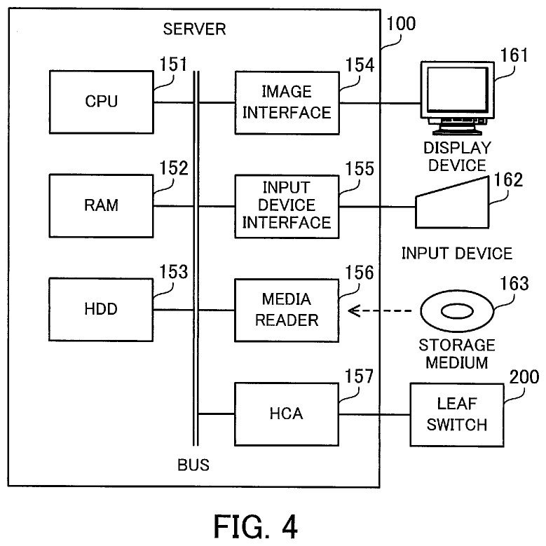

FIG. 4 is a block diagram illustrating an exemplary hardware configuration of a server.

The server 100 includes a CPU 151, a RAM 152, an HDD 153, an image interface 154, an input device interface 155, a media reader 156, and a host channel adapter (HCA) 157. These units are individually connected to a bus. Other servers and the job scheduler 300 have the same hardware configuration as the server 100.

The CPU 151 is a processor configured to execute program instructions. The CPU 151 reads out at least part of programs and data stored in the HDD 153, loads them into the RAM 152, and executes the loaded programs. Note that the CPU 151 may include two or more processor cores and the server 100 may include two or more processors. The term “multiprocessor”, or simply “processor”, may be used to refer to a set of processors.

The RAM 152 is volatile semiconductor memory for temporarily storing therein programs to be executed by the CPU 151 and data to be used by the CPU 151 for its computation. Note that the server 100 may be provided with a different type of memory other than RAM, or may be provided with two or more memory devices.

The HDD 153 is a non-volatile storage device to store therein software programs, such as an operating system (OS), middleware, and application software, and various types of data. Note that the server 100 may be provided with a different type of storage device, such as flash memory or a solid state drive (SSD), or may be provided with two or more storage devices.

The image interface 154 produces video images in accordance with drawing commands from the CPU 151 and displays them on a screen of a display device 161 coupled to the server 100. The display device 161 may be any type of display, such as a cathode ray tube (CRT) display; a liquid crystal display (LCD); an organic electro-luminescence (OEL) display, or a projector. In addition, an output device, such as a printer, other than the display device 161 may also be connected to the server 100.

The input device interface 155 receives an input signal from an input device 162 connected to the server 100. Various types of input devices may be used as the input device 162, for example, a mouse, a touch panel, a touch-pad, or a keyboard. A plurality of types of input devices may be connected to the server 100.

The media reader 156 is a device for reading programs and data recorded on a storage medium 163. Various types of storage media may be used as the storage medium 163, for example, a magnetic disk such as a flexible disk (FD) or an HDD, an optical disk such as a compact disc (CD) or a digital versatile disc (DVD), and semiconductor memory. The media reader 156 copies the programs and data read out from the storage medium 163 to a different storage medium, for example, the RAM 152 or the HDD 153. The read programs are executed, for example, by the CPU 151. Note that the storage medium 163 may be a portable storage medium and used to distribute the programs and data. In addition, the storage medium 163 and the HDD 153 are sometimes referred to as computer-readable storage media.

The HCA 157 is an InfiniBand communication interface. The HCA 157 supports full-duplex communication and is able to concurrently process data transmission and reception. The HCA 157 is connected to the leaf switch 200. Note however that the server 100 may be provided with a communication interface using a different communication standard in place of or in addition to the HCA 157.

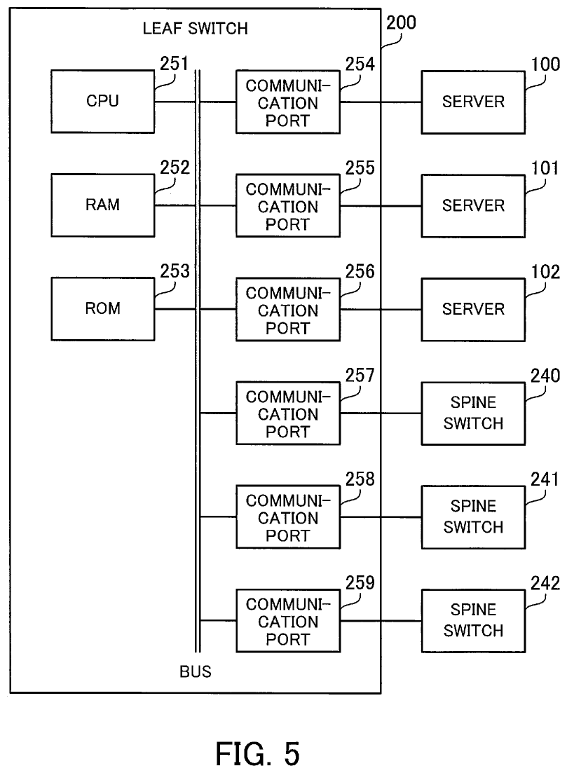

FIG. 5 is a block diagram illustrating an exemplary hardware configuration of a switch.

The leaf switch 200 includes a CPU 251, a RAM 252, a read-only memory (ROM) 253, and communication ports 254, 255, 256, 257, 258, and 259. Other leaf switches and spine switches have the same hardware configuration as the leaf switch 200.

The CPU 251 is a processor configured to execute a communication control program. According to the communication control program, the CPU 251 sends out a received packet to a communication port appropriate for a destination of the packet. The CPU 251 reads out at least part of the communication control program stored in the ROM 253, loads it into the RAM 252, and executes the loaded communication control program. Note however that at least part of communication control may be implemented using a dedicated hardware circuit.

The RAM 252 is volatile semiconductor memory for temporarily storing therein the communication control program to be executed by the CPU 251 and data to be used for communication control. The data includes routing information indicating mappings between packet destinations and output communication ports. The ROM 253 is a non-volatile storage device to store therein the communication control program. Note however that the leaf switch 200 may be equipped with a rewritable non-volatile storage device such as flash memory.

The communication ports 254, 255, 256, 257, 258, and 259 are InfiniBand communication interfaces. Each of the communication ports 254, 255, 256, 257, 258, and 259 supports full-duplex communication and is able to concurrently process data transmission and reception. The communication port 254 is connected to the server 100. The communication port 255 is connected to the server 101. The communication port 256 is connected to the server 102. The communication port 257 is connected to the spine switch 240. The communication port 258 is connected to the spine switch 241. The communication port 259 is connected to the spine switch 242. Note however that the leaf switch 200 may be provided with communication interfaces using a different communication standard in place of or in addition to the communication ports 254, 255, 256, 257, 258, and 259.

Next described is collective communication on the multi-layer full mesh system.

A plurality of processes belonging to the same job sometimes performs collective communication in which the multiple processes participate in data transmission all together. A user program invokes an MPI collective communication command, thereby initiating concurrent data transmission.

A reduce operation is one type of collective communication. In the reduce operation, data of all other processes is consolidated and gathered in a particular process, e.g. a process with a rank of 0 (hereinafter sometimes referred to as “rank-0 process” for convenience, and similar notations are used for other processes). Given one node being assigned one process, the reduce operation is deemed as transmission of data of other servers (nodes) to a particular server (node). It is often the case that a plurality of processes individually has different data. The data to be consolidated may be result data representing results of job execution, or may be intermediate data representing progress of the job.

A broadcast operation is another type of collective communication. In the broadcast operation, data of a particular process, e.g. the rank-0 process, is copied to all other processes. Given one node being assigned one process, the broadcast operation is deemed as transmission of the same data from a server (node) to all other servers (nodes). The data to be copied may be input data to be entered into each process.

An allreduce operation is yet another type of collective communication. In the allreduce operation, entire data of a plurality of processes is copied to all the processes. The allreduce operation is divided into a process of consolidating data of the multiple processes and a process of copying the consolidated data to all the processes. Therefore, the allreduce operation is implemented by combining reduce and broadcast operations.

A tree algorithm is one type of collective communication algorithm. Collective communication routines described below are assumed to be mainly reduce operations.

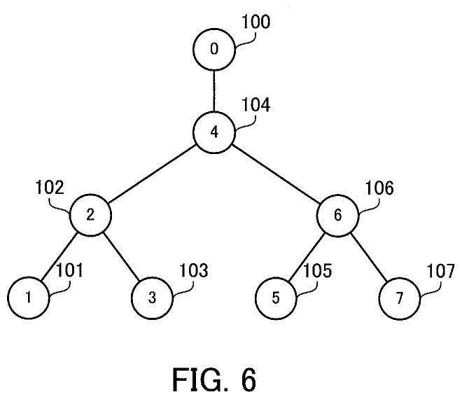

FIG. 6 illustrates an exemplary tree algorithm.

Assume here that the server 100 executes the rank-0 process; the server 101 executes a rank-1 process; the server 102 executes a rank-2 process; and the server 103 executes a rank-3 process. Also assume that the server 104 executes a rank-4 process; the server 105 executes a rank-5 process; the server 106 executes a rank-6 process; and the server 107 executes a rank-7 process.

In the tree algorithm, a communication procedure among the multiple servers is determined such that their communication peers are organized into a binary tree topology. Each server other than one at the root of the tree communicates with a server located at one level higher than the server (i.e., one level closer to the root). Each server other than those at the leaves communicates with a maximum of two servers located at one level lower than the server (one level closer to the leaves). The processes constituting a tree are mapped in the tree such that in-order traversal on the tree visits the processes in ascending order of their rank numbers. The rank of a process assigned to a server is greater than that of a process assigned to its lower-left server and less than that of a process assigned to its lower-right server. Note, however, that although the communication peers of the multiple servers need to be organized in a tree structure, the ranks need not be arranged in in-order.

Communication between a server and its lower-left server uses the same link as communication between the server and its lower-right server, and therefore they are not performed in parallel. As a result, communication at each level with a bifurcation or bifurcations on the tree is divided into two phases, i.e., left-hand and right-hand communication phases. Communication at a level with no bifurcation is performed in one phase.

A reduce operation is expressed as data transfer from the leaves of the tree toward the root. A broadcast operation is expressed as data transfer from the root of the tree toward the leaves. An allreduce operation is expressed as data transfer from the leaves of the tree toward the root, followed by data transfer from the root toward the leaves.

In the example of FIG. 6, the server 100 is located at the root of the tree while the servers 101, 103, 105, and 107 are at the leaves. The server 101 communicates with the server 102, in parallel with which the server 105 communicates with the server 106. The server 103 communicates with the server 102, in parallel with which the server 107 communicates with the server 106. The server 102 communicates with the server 104. The server 106 communicates with the server 104. The server 104 communicates with the server 100.

In the case of a reduce operation, the server 101 transmits its data to the server 102, in parallel with which the server 105 transmits its data to the server 106. The server 103 transmits its data to the server 102, in parallel with which the server 107 transmits its data to the server 106. The server 102 transmits data of the servers 101, 102, and 103 to the server 104. The server 106 transmits data of the servers 105, 106, and 107 to the server 104. Finally, the server 104 transmits data of the servers 101, 102, 103, 104, 105, 106, and 107 to the server 100.

Herewith, the data of the servers 100, 101, 102, 103, 104, 105, 106, and 107 is consolidated and gathered in the server 100. As described above, each server other than those at the leaves and the root receives data from its two lower-level servers, adds its own data to the received data, and then transfers the combined data to its higher-level server. Note that either one of the left-hand communication and the right-hand communication at the same level in the tree may be performed first. In addition, after being split into a plurality of blocks, data may be pipelined one block at a time. In this case, each server other than those at the leaves and the root is able to perform in parallel reception of a block from its lower-level server and transmission of another block to its higher-level server.

In the case of a broadcast operation, the server 100 copies data and transmits it to the server 104. The server 104 copies the received data and transmits it to the server 106. The server 104 also copies the received data and transmits it to the server 102. The server 106 copies the received data and transmits it to the server 107, in parallel with which the server 102 copies the received data and transmits it to the server 103. The server 106 copies the received data and transmits it to the server 105, in parallel with which the server 102 copies the received data and transmits it to the server 101.

Herewith, the data of the server 100 is copied to the servers 101, 102, 103, 104, 105, 106, and 107. As described above, each server other than those at the leaves and the root receives data from its higher-level server and transfers the received data to its two lower-level servers. Note that the data may be pipelined as above stated. In this case, each server other than those at the leaves and the root is able to perform in parallel reception of a block from its higher-level server and transmission of another block to its lower-level server.

The following description assumes that data split into blocks is pipelined.

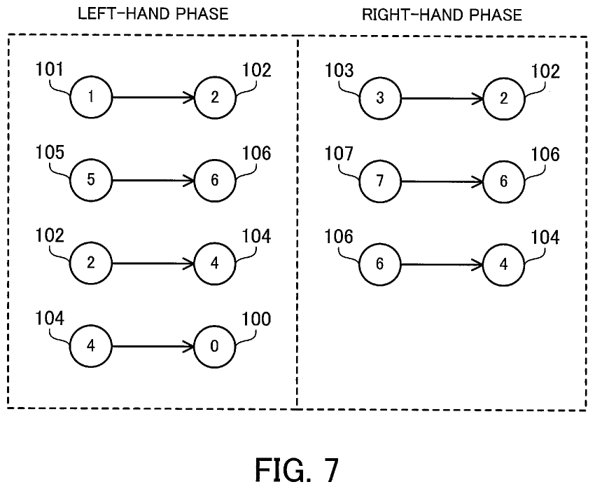

FIG. 7 illustrates an exemplary transmission and reception relationship in a reduce operation based on the tree.

Also in pipeline communication, because each server uses the same link to communicate with its reception/transmission peers, it neither receives nor transmits blocks from and to two different servers in parallel. On the other hand, each server supports full-duplex communication and is therefore able to simultaneously perform reception of a block from a server and transmission of a block to the server.

In view of the above, the interserver communication according to the tree of FIG. 6 is divided into two phases as illustrated in FIG. 7. In each phase, communication between different pairs of nodes is performed in parallel. The two phases are repeated alternately until transfer of the multiple split blocks is completed.

A method adopted here is to assign the left-edge communication and the right-edge communication on the tree of FIG. 6 into different phases. Then, in the case of a reduce operation, the left-hand phase includes transmission from the server 101 to the server 102; transmission from the server 105 to the server 106; transmission from the server 102 to the server 104; and transmission from the server 104 to the server 100. On the other hand, the right-hand phase includes transmission from the server 103 to the server 102; transmission from the server 107 to the server 106; and transmission from the server 106 to the server 104.

Note however that since pipelining is employed here, all the communication defined for each phase in FIG. 7 is not necessarily performed in the phase. Each source server does not perform data transmission when a block to be transferred has not yet arrived. In addition, each source server does not perform data transmission when transfer of all blocks is completed and no more block to be transferred next is left.

For example, in the first left-hand phase, each of the servers 101 and 105 transmits its first block. At this time, the servers 102 and 104 do not perform data transmission. Next, in the first right-hand phase, each of the servers 103 and 107 transmits its first block. At this time, the server 106 does not perform data transmission.

Subsequently, in the second left-hand phase, each of the servers 101 and 105 transmits its second block. In addition, the server 102 transmits a reduction result associated with the first blocks of the servers 101, 102, and 103 to the server 104. At this time, the server 104 does not perform data transmission. Next, in the second right-hand phase, each of the servers 103 and 107 transmits its second block. In addition, the server 106 transmits a reduction result associated with the first blocks of the servers 105, 106, and 107 to the server 104.

Subsequently, in the third left-hand phase, each of the servers 101 and 105 transmits its third block. In addition, the server 102 transmits a reduction result associated with the second blocks of the servers 101, 102, and 103 to the server 104. Further, the server 104 transmits a reduction result associated with the first blocks of the servers 101, 102, 103, 104, 105, 106, and 107 to the server 100. Next, in the third right-hand phase, each of the servers 103 and 107 transmits its third block. In addition, the server 106 transmits a reduction result associated with the second blocks of the servers 105, 106, and 107 to the server 104. In this manner, a plurality of blocks is transferred in a pipelined fashion.

Note, however, that while servers individually have communication band for both data transmission and reception, a plain tree algorithm causes a lot of idle time on each server during which at least one of the data transmission and reception is not performed in spite of pipelining being adopted. For this reason, the communication band is underused, which in turn could increase the time needed for collective communication. To solve this problem, two-tree algorithms have been proposed, which are an improvement in tree algorithms.

The following non-patent literature, for example, includes details about two-tree algorithms: Peter Sanders, Jochen Speck and Jesper Larsson TrAff, “Two-tree algorithms for full bandwidth broadcast, reduction and scan”, ScienceDirect Parallel Computing, Volume 35, Issue 12, pp. 581-594, December 2009.

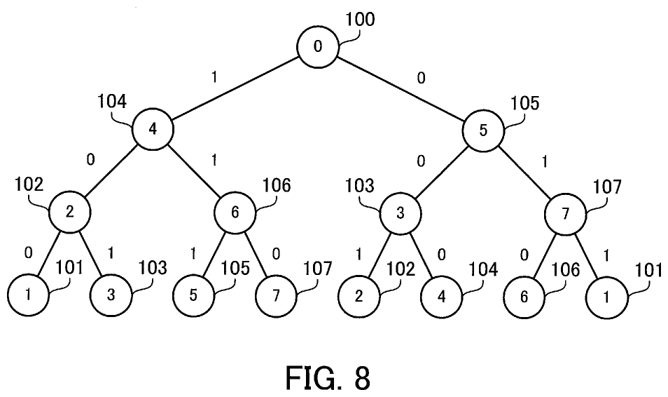

FIG. 8 illustrates an exemplary two-tree algorithm.

In the two-tree algorithm, two subtrees with different communication procedures among servers other than one at the root are generated, and the two subtrees and the root are joined to form a single two tree. One of the subtrees may be generated, for example, by cyclic shifting each rank in the other subtree to the next one. Note however that a method other than cyclic shifting may be employed to generate the second subtree.

Communication proceeds in parallel along the two subtrees. An entire data set is split into two, one of which is transferred according to one of the subtrees while the other is transferred according to the other subtree. The two-tree algorithm aims at reducing the time needed for collective communication by fully exploiting communication band of the links, unused by the plain tree algorithm. Note here that, in the case of the two-tree algorithm, if left-edge communication and right-edge communication in the two tree is simply split into different phases, a case may arise where one server carries out block transmission or reception more than once in the same phase. To address this problem, a method of communication scheduling called coloring is proposed, for example, in the above-cited non-patent literature. The coloring allows most of the servers to perform at most one transmission and at most one reception in each phase. On the other hand, no server transmits data to two different servers in the same phase. In addition, no server receives data from two different servers in the same phase.

FIG. 8 depicts exemplary coloring. Numbers assigned to edges represent colors. Communication to which the same color is assigned is grouped into the same phase. Therefore, from the two tree of FIG. 8, a color-0 phase and a color-1 phase are formed. Communication belonging to the color-0 phase may be carried out in parallel. In addition, communication belonging to the color-1 phase may be carried out in parallel. The color-0 and color-1 phases are performed alternately.

In the example of FIG. 8, the server 101 communicates with the server 102, in parallel with which the server 107 communicates with the server 106, in parallel with which the server 104 communicates with the server 103, in parallel with which the server 106 communicates with the server 107. The server 103 communicates with the server 102, in parallel with which the server 105 communicates with the server 106, in parallel with which the server 102 communicates with the server 103, in parallel with which the server 101 communicates with the server 107. The server 102 communicates with the server 104, in parallel with which the server 103 communicates with the server 105. The server 106 communicates with the server 104, in parallel with which the server 107 communicates with the server 105. The server 105 communicates with the server 100. The server 104 communicates with the server 100.

In the case of a reduce operation, the server 101 transmits half the data of the server 101 to the server 102, in parallel with which the server 107 transmits half the data of the server 107 to the server 106. In addition, the server 104 transmits half the data of the server 104 to the server 103, in parallel with which the server 106 transmits half the data of the server 106 to the server 107.

The server 102 transmits a reduction result associated with the halves of the data of the servers 101, 102, and 103 to the server 104, in parallel with which the server 103 transmits a reduction result associated with the halves of the data of the servers 102, 103, and 104 to the server 105. In addition, the server 106 transmits a reduction result associated with the halves of the data of the servers 105, 106, and 107 to the server 104, in parallel with which the server 107 transmits a reduction result associated with the halves of the data of the servers 101, 106, and 107 to the server 105.

The server 105 transmits a reduction result associated with the halves of the data of the servers 101, 102, 103, 104, 105, 106, and 107 to the server 100. The server 104 transmits a reduction result associated with the halves of the data of the servers 101, 102, 103, 104, 105, 106, and 107 to the server 100.

In the case of a broadcast operation, the server 100 copies half of data and transmits it to the server 105. The server 100 copies half of the data and transmits it to the server 104. The server 105 transmits the received half data to the server 103, in parallel with which the server 104 transmits the received half data to the server 102. In addition, the server 105 transmits the received half data to the server 107, in parallel with which the server 104 transmits the received half data to the server 106.

The server 107 transmits the received half data to the server 106, in parallel with which the server 103 transmits the received half data to the server 104. Further, the server 106 transmits the received half data to the server 107, in parallel with which the server 102 transmits the received half data to the server 101. Then, the server 107 transmits the received half data to the server 101, in parallel with which the server 103 transmits the received half data to the server 102. Further, the server 106 transmits the received half data to the server 105, in parallel with which the server 102 transmits the received half data to the server 103.

The above-mentioned data communication may be pipelined. In this case, for each of the left and right subtrees, the split data is further divided into a plurality of blocks, which is then transferred in a pipelined fashion.

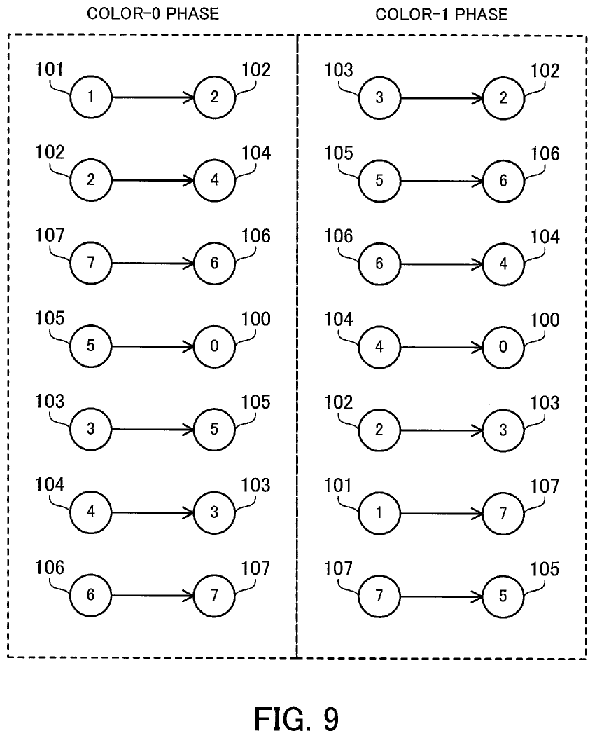

FIG. 9 illustrates an exemplary transmission and reception relationship in the reduce operation based on the two tree.

The color-0 phase of the reduce operation includes transmission from the server 101 to the server 102; transmission from the server 102 to the server 104; transmission from the server 107 to the server 106; and transmission from the server 105 to the server 100. The color-0 phase also includes transmission from the server 103 to the server 105; transmission from the server 104 to the server 103; and transmission from the server 106 to the server 107.

The color-1 phase of the reduce operation includes transmission from the server 103 to the server 102; transmission from the server 105 to the server 106; transmission from the server 106 to the server 104; and transmission from the server 104 to the server 100. The color-1 phase also includes transmission from the server 102 to the server 103; transmission from the server 101 to the server 107; and transmission from the server 107 to the server 105.

For example, in the first color-0 phase, each of the servers 101, 104, 106, and 107 transmits its first block. Next, in the first color-1 phase, each of the servers 101, 102, 103, and 105 transmits its first block.

Subsequently, in the second color-0 phase, each of the servers 101, 104, 106, and 107 transmits its second block. In addition, each of the servers 102 and 103 transmits a reduction result associated with the first blocks. Next, in the second color-1 phase, each of the servers 101, 102, 103, and 105 transmits its second block. In addition, each of the servers 106 and 107 transmits a reduction result associated with the first blocks.

Subsequently, in the third color-0 phase, each of the servers 101, 104, 106, and 107 transmits its third block. In addition, each of the servers 102 and 103 transmits a reduction result associated with the second blocks. Further, the server 105 transmits a reduction result associated with the first blocks. Next, in the third color-1 phase, each of the servers 101, 102, 103, and 105 transmits its third block. In addition, each of the servers 106 and 107 transmits a reduction result associated with the second blocks. Further, the server 104 transmits a reduction result associated with the first blocks.

Note that the two-tree algorithm achieves increased parallelism of data communication compared to the tree algorithm. Therefore, depending on the layout of the processes, there is an increased chance of causing data communication conflicts. The case where, during a single phase, two data sets are communicated using the same link in the same direction is considered as an occurrence of a data communication conflict (or collision). The data communication conflict is likely to cause a communication delay due to an occurrence of packets awaiting transmission, division of the communication band of a link and the like, which results in increased communication time. Next described is a communication conflict.

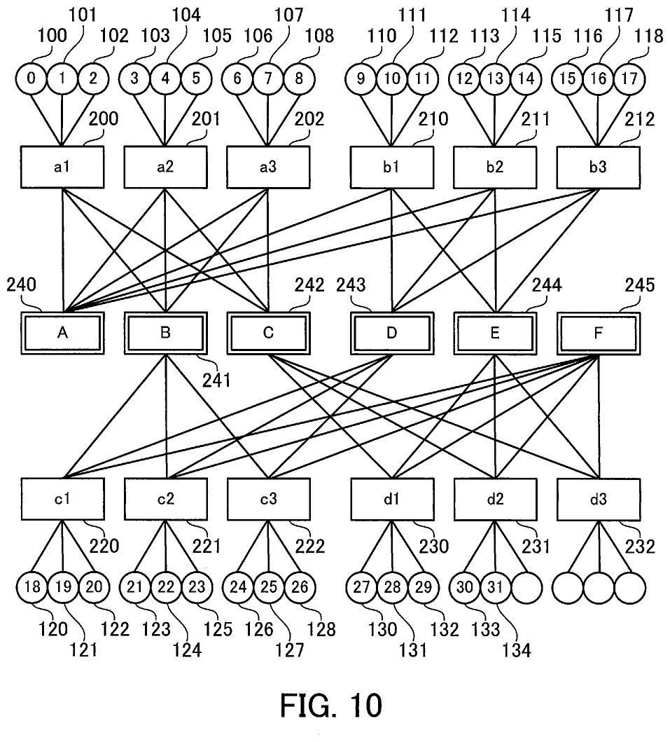

FIG. 10 illustrates a first example of process assignment.

The following explains a communication conflict example, assuming that thirty-two processes with ranks of 0 to 31 are assigned to thirty-two servers out of thirty-six servers.

Here, the processes with ranks of 0, 1, 2, 3, 4, 5, 6, 7, and 8 are assigned to servers 100, 101, 102, 103, 104, 105, 105, 107, and 108 of Group a. The processes with ranks of 9, 10, 11, 12, 13, 14, 15, 16, and 17 are assigned to servers 110, 111, 112, 113, 114, 115, 116, 117, and 118 of Group b. The processes with ranks of 18, 19, 20, 21, 22, 23, 24, 25, and 26 are assigned to servers 120, 121, 122, 123, 124, 125, 126, 127, and 128 of Group c. The processes with ranks of 27, 28, 29, 30, and 31 are assigned to servers 130, 131, 132, 133, and 134 of Group d.

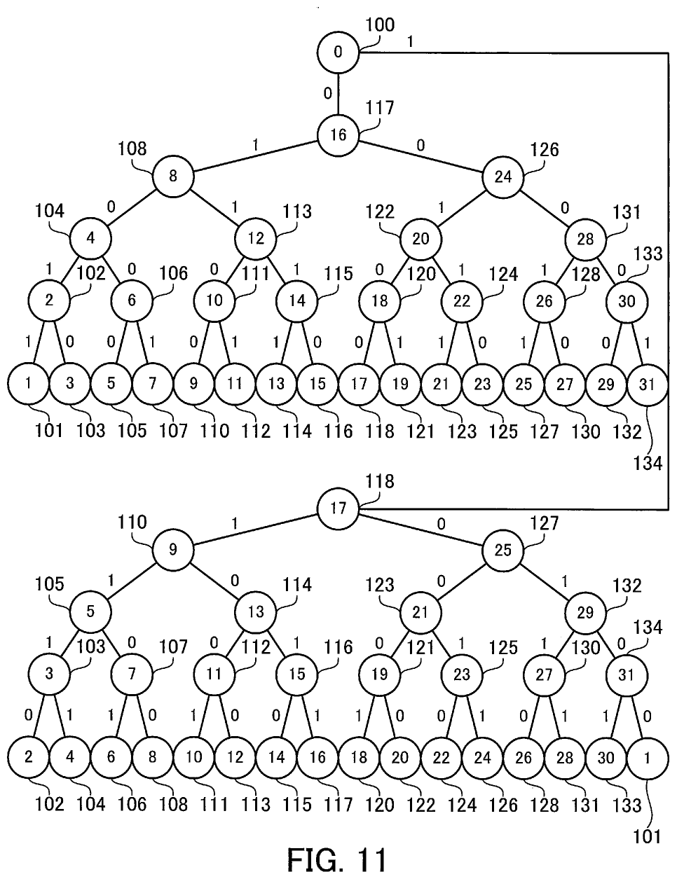

FIG. 11 illustrates exemplary two-tree generation.

A two tree is generated with the thirty-two processes with ranks of 0 to 31.

In the left subtree, data communication is performed in parallel between the servers 103, 105, 110, 116, 118, 125, 130, and 132 and the servers 102, 106, 111, 115, 120, 124, 128, and 133, respectively. Data communication is performed in parallel between the servers 101, 107, 112, 114, 121, 123, 127, and 134 and the servers 102, 106, 111, 115, 120, 124, 128, and 133, respectively.

In addition, data communication is performed in parallel between the servers 106, 111, 120, and 133 and the servers 104, 113, 122, and 131, respectively. Data communication is performed in parallel between the servers 102, 115, 124, and 128 and the servers 104, 113, 122, and 131, respectively. Data communication is performed in parallel between the servers 104 and 131 and the servers 108 and 126, respectively. Data communication is performed in parallel between the servers 113 and 122 and the servers 108 and 126, respectively. Data communication is performed between the servers 126 and 117. Data communication is performed between the servers 108 and 117. Data communication is performed between the servers 117 and 100.

In the right subtree, data communication is performed in parallel between the servers 102, 108, 113, 115, 122, 124, 128, and 101 and the servers 103, 107, 112, 116, 121, 125, 130, and 134, respectively. Data communication is performed in parallel between the servers 104, 106, 111, 117, 120, 126, 131, and 133 and the servers 103, 107, 112, 116, 121, 125, 130, and 134, respectively.

In addition, data communication is performed in parallel between the servers 107, 112, 121, and 134 and the servers 105, 114, 123, and 132, respectively. Data communication is performed in parallel between the servers 103, 116, 125, and 130 and the servers 105, 114, 123, and 132, respectively. Data communication is performed in parallel between the servers 114 and 123 and the servers 110 and 127, respectively. Data communication is performed in parallel between the servers 105 and 132 and the servers 110 and 127, respectively. Data communication is performed between the servers 127 and 118. Data communication is performed between the servers 110 and 118. Data communication is performed between the servers 118 and 100.

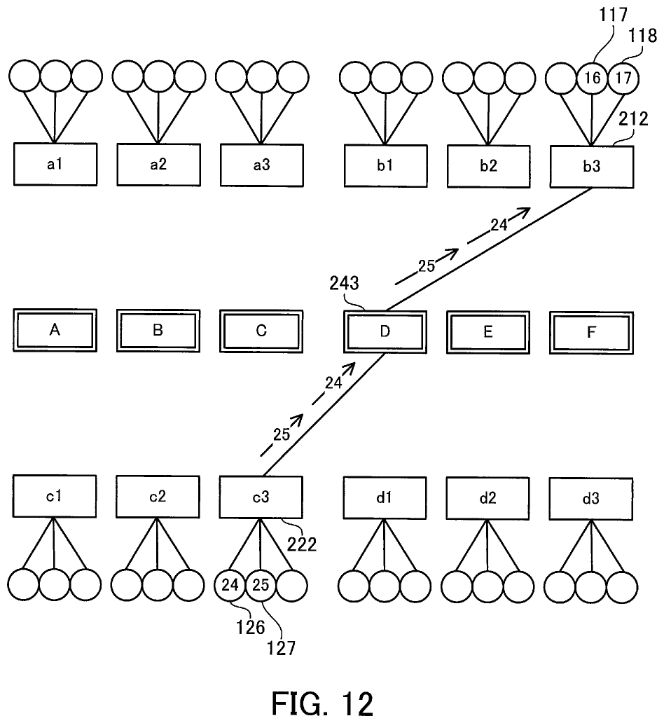

FIG. 12 illustrates an exemplary conflict in a reduce operation.

In the case of performing a reduce operation according to the two tree of FIG. 11 above, communication conflicts occur in the multi-layer full mesh system of the second embodiment. For example, in the left subtree, data transmission from the server 126 assigned the rank-24 process to the server 117 assigned the rank-16 process is determined. On the other hand, in the right subtree, data transmission from the server 127 assigned the rank-25 process to the server 118 assigned the rank-17 process at the same level is determined. Both of these two events of data communication use a communication path passing sequentially through the leaf switch 222, the spine switch 243, and the leaf switch 212, thus causing a communication conflict.

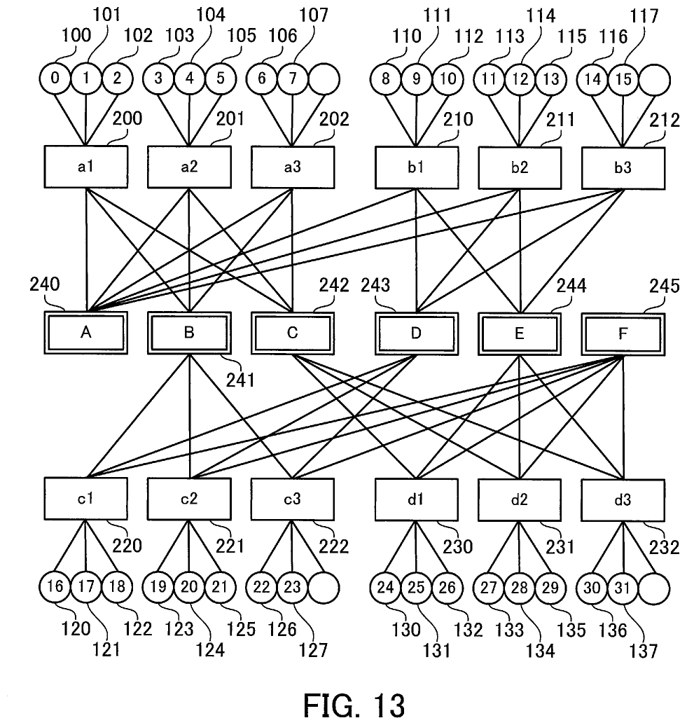

FIG. 13 illustrates a second example of process assignment.

Let us consider another example of assignment of the thirty-two processes with ranks of 0 to 31.

Here, the processes with ranks of 0, 1, 2, 3, 4, 5, 6, and 7 are assigned to the servers 100, 101, 102, 103, 104, 105, 106, and 107 of Group a. The processes with ranks of 8, 9, 10, 11, 12, 13, 14, and 15, are assigned to the servers 110, 111, 112, 113, 114, 115, 116, and 117 of Group b. The processes with ranks of 16, 17, 18, 19, 20, 21, 22, and 23 are assigned to the servers 120, 121, 122, 123, 124, 125, 126, and 127 of Group c. The processes with ranks of 24, 25, 26, 27, 28, 29, 30, and 31 are assigned to the servers 130, 131, 132, 133, 134, 135, 136, and 137 of Group d.

The processes are equally assigned to all Groups a, b, c, and d as represented in FIG. 13; however, communication conflicts occur when a reduce operation is performed according to the two tree. For example, in the left subtree, data transmission from the server 130 assigned the rank-24 process to the server 120 assigned the rank-16 process is determined. On the other hand, in the right subtree, data transmission from the server 131 assigned the rank-25 process to the server 121 assigned the rank-17 process at the same level is determined. Both of these two events of data communication use a communication path passing sequentially through the leaf switch 230, the spine switch 245, and the leaf switch 220, thus causing a communication conflict.

In view of the above, the multi-layer full mesh system according to the second embodiment determines a collective communication procedure such that no communication conflicts occur. Specifically, one representative process is selected from each group, and a local two tree composed of a plurality of processes belonging to the group is generated, in which the representative process is at the root. Within the group, data is transferred according to the local two tree. In addition, separately from the local two trees, a global two tree is generated, which is composed of the representative processes individually corresponding to each of the groups. Between the groups, data is transferred according to the global two tree. The representative process of each group is, for example, a process with the lowest rank in the group. Note however that another selection criterion may be adopted as long as one representative process is selected for each group.

In the case of a reduce operation, within each group, data is consolidated and gathered in the representative process according to the local two tree. The intragroup communication of the multiple groups is carried out in parallel. Following the intragroup communication, data across the groups is consolidated and gathered in one process according to the global two tree. In the case of a broadcast operation, data of one process is copied to the representative process of each group according to the global two tree. Following the intergroup communication, the data is copied within each group from the representative process to other processes according to the local two tree. The intragroup communication of the multiple groups is carried out in parallel. Next described is a collective communication procedure according to the second embodiment.

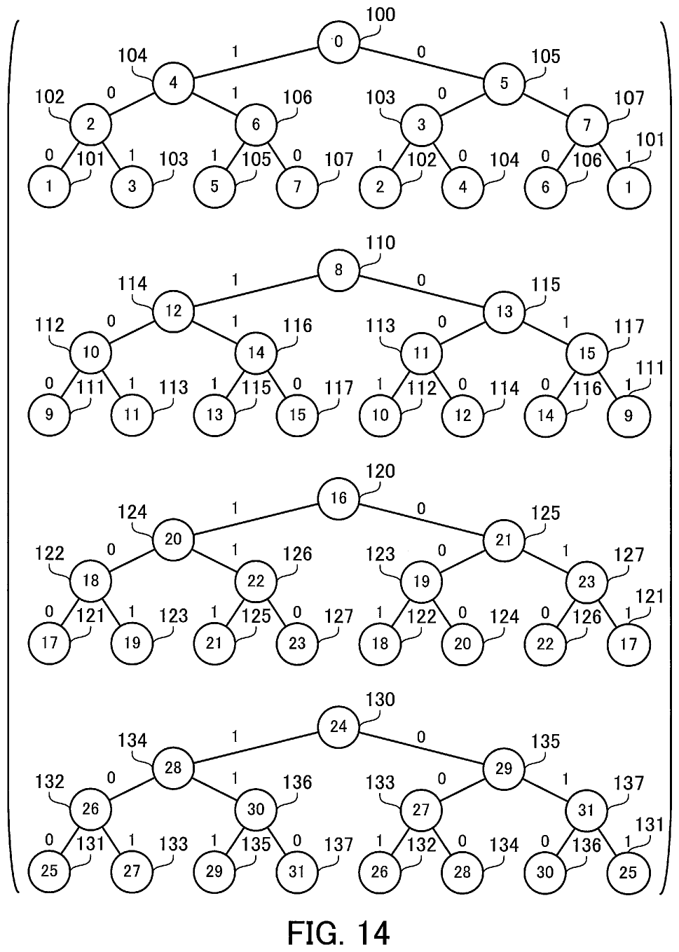

FIG. 14 illustrates exemplary local two-tree generation.

Assume here that the thirty-two processes are assigned as represented in FIG. 13. The thirty-two processes are distributed equally among Groups a, b, c, and d, that is, eight processes per group. Therefore, four local two trees corresponding to Groups a, b, c, and d are generated.

In the local two tree of Group a, the rank-0 process is the representative process. The right subtree is generated by cyclic shifting each rank in the left subtree to the next one. The servers 101 and 107 communicate with the servers 102 and 106, respectively, in parallel with which the servers 104 and 106 communicate with the servers 103 and 107, respectively (the first level in the color-0 phase). The servers 103 and 105 communicate with the servers 102 and 106, respectively, in parallel with which the servers 102 and 101 communicate with the servers 103 and 107, respectively (the first level in the color-1 phase). The server 102 communicates with the server 104, in parallel with which the server 103 communicates with the server 105 (the second level in the color-0 phase). The server 106 communicates with the server 104, in parallel with which the server 107 communicates with the server 105 (the second level in the color-1 phase). The server 105 communicates with the server 100 (the third level in the color-0 phase). The server 104 communicates with the server 100 (the third level in the color-1 phase).

In the local two tree of Group b, the rank-8 process is the representative process. The right subtree is generated by cyclic shifting each rank in the left subtree to the next one. The servers 111 and 117 communicate with the servers 112 and 116, respectively, in parallel with which the servers 114 and 116 communicate with the servers 113 and 117, respectively (the first level in the color-0 phase). The servers 113 and 115 communicate with the servers 112 and 116, respectively, in parallel with which the servers 112 and 111 communicate with the servers 113 and 117, respectively (the first level in the color-1 phase). The server 112 communicates with the server 114, in parallel with which the server 113 communicates with the server 115 (the second level in the color-0 phase). The server 116 communicates with the server 114, in parallel with which the server 117 communicates with the server 115 (the second level in the color-1 phase). The server 115 communicates with the server 110 (the third level in the color-0 phase). The server 114 communicates with the server 110 (the third level in the color-1 phase).

In the local two tree of Group c, the rank-16 process is the representative process. The right subtree is generated by cyclic shifting each rank in the left subtree to the next one. The servers 121 and 127 communicate with the servers 122 and 126, respectively, in parallel with which the servers 124 and 126 communicate with the servers 123 and 127, respectively (the first level in the color-0 phase). The servers 123 and 125 communicate with the servers 122 and 126, respectively, in parallel with which the servers 122 and 121 communicate with the servers 123 and 127, respectively (the first level in the color-1 phase). The server 122 communicates with the server 124, in parallel with which the server 123 communicates with the server 125 (the second level in the color-0 phase). The server 126 communicates with the server 124, in parallel with which the server 127 communicates with the server 125 (the second level in the color-1 phase). The server 125 communicates with the server 120 (the third level in the color-0 phase). The server 124 communicates with the server 120 (the third level in the color-1 phase).

In the local two tree of Group d, the rank-24 process is the representative process. The right subtree is generated by cyclic shifting each rank in the left subtree to the next one. The servers 131 and 137 communicate with the servers 132 and 136, respectively, in parallel with which the servers 134 and 136 communicate with the servers 133 and 137, respectively (the first level in the color-0 phase). The servers 133 and 135 communicate with the servers 132 and 136, respectively, in parallel with which the servers 132 and 131 communicate with the servers 133 and 137, respectively (the first level in the color-1 phase). The server 132 communicates with the server 134, in parallel with which the server 133 communicates with the server 135 (the second level in the color-0 phase). The server 136 communicates with the server 134, in parallel with which the server 137 communicates with the server 135 (the second level in the color-1 phase). The server 135 communicates with the server 130 (the third level in the color-0 phase). The server 134 communicates with the server 130 (the third level in the color-1 phase).

In the case of a reduce operation, within Group a, data of the processes with ranks of 0, 1, 2, 3, 4, 5, 6, and 7 is consolidated and gathered in the server 100 according to its local two tree. Within Group b, data of the processes with ranks of 8, 9, 10, 11, 12, 13, 14, and is consolidated and gathered in the server 110 according to its local two tree. Within Group c, data of the processes with ranks of 16, 17, 18, 19, 20, 21, 22, and 23 is consolidated and gathered in the server 120 according to its local two tree. Within Group d, data of the processes with ranks of 24, 25, 26, 27, 28, 29, 30, and 31 is consolidated and gathered in the server 130 according to its local two tree.

In the case of a broadcast operation, the servers 100, 110, 120, and 130 retain the same data through intergroup communication based on the global two tree. Then, in Group a, the data is copied from the server 100 to the remaining servers according to its local two tree. In Group b, the data is copied from the server 110 to the remaining servers according to its local two tree. In Group c, the data is copied from the server 120 to the remaining servers according to its local two tree. In Group d, the data is copied from the server 130 to the remaining servers according to its local two tree.

In the case of performing the reduce operation in a pipelined fashion, while the first level in the color-0 phase transmits the first blocks, the second and third levels in the color-0 phase do not perform data transmission. While the first level in the color-1 phase transmits the first blocks, the second and third levels in the color-1 phase do not perform data transmission. While the first level in the color-0 phase transmits the second blocks, the second level in the color-0 phase transmits the first blocks and the third level in the color-0 phase does not perform data transmission. While the first level in the color-1 phase transmits the second blocks, the second level in the color-1 phase transmits the first blocks and the third level in the color-1 phase does not perform data transmission. While the first level in the color-0 phase transmits the third blocks, the second level in the color-0 phase transmits the second blocks and the third level in the color-0 phase transmits the first blocks. While the first level in the color-1 phase transmits the third blocks, the second level in the color-1 phase transmits the second blocks and the third level in the color-1 phase transmits the first blocks.

The above-described intragroup communication is able to avoid communication conflicts. This is because the intragroup network corresponds to a fat tree topology. The fat tree topology is a network topology for relieving traffic congestion by multiplexing higher-level communication devices included in a tree topology to thereby multiplex communication paths between different lower-level communication devices.

In the multi-layer full mesh system according to the second embodiment, the number of links that each of three leaf switches has on the spine switch side is three, which is the same as the number of links on the server side. In addition, each leaf switch has three communication paths to reach a different leaf switch. That is, the total number of communication paths between three leaf switches and three spine switches is nine, which is the same as the number of servers connected to three leaf switches. Therefore, by assigning one of the communication paths between the leaf switches and the spine switches to each server, nine servers are able to perform data communication without conflicts.

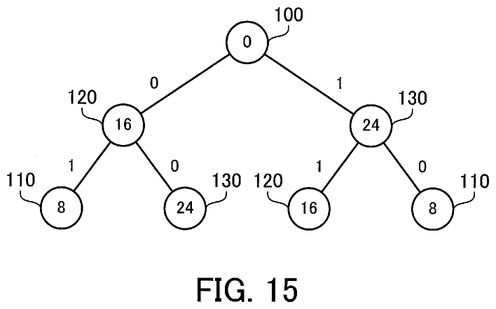

FIG. 15 illustrates exemplary global two-tree generation.

In addition to the individual local two trees for Groups a, b, c, and d, the global two tree is generated, which is composed of the processes with ranks of 0, 8, 16, and 24, i.e., the representative processes of Groups a, b, c, and d. The rank-0 process is at the root of the global two tree. The right subtree is generated by cyclic shifting each rank in the left subtree to the next one. The server 130 communicates with the server 120, in parallel with which the server 110 communicates with the server 130 (the first level in the color-0 phase). The server 110 communicates with the server 120, in parallel with which the server 120 communicates with the server 130 (the first level in the color-1 phase). The server 120 communicates with the server 100 (the second level in the color-0 phase). The server 130 communicates with the server 100 (the second level in the color-1 phase).

In the case of a reduce operation, data of the processes with ranks of 8, 9, 10, 11, 12, 13, 14, and 15 consolidated and gathered in the server 110 according to a local two tree is transferred to the server 100. Similarly, data of the processes with ranks of 16, 17, 18, 19, 20, 21, 22, and 23 consolidated and gathered in the server 120 according to a local two tree is transferred to the server 100. In addition, data of the processes with ranks of 24, 25, 26, 27, 28, 29, 30, and 31 consolidated and gathered in the server 130 according to a local two tree is transferred to the server 100. In the case of a broadcast operation, data held by the server 100 is copied to the servers 110, 120, and 130.

A whole reduce operation is implemented by carrying out a reduce operation according to the local two trees, followed by a reduce operation according to the global two tree. A whole broadcast operation is implemented by carrying out a broadcast operation according to the global two tree, followed by a broadcast operation according to the local two trees. A whole allreduce operation is implemented by sequentially carrying out the following operations in the stated order: a reduce operation according to the local two trees; a reduce operation according to the global two tree; a broadcast operation according to the global two tree; and a broadcast operation according to the local two trees. In other words, a whole allreduce operation is implemented by sequentially carrying out a reduce operation according to the local two trees; an allreduce operation according to the global two tree; and a broadcast operation according to the local two trees.

As described above, conflicts in the intergroup communication are avoided by selecting a representative process from each group and allowing only servers assigned the representative processes to carry out communication. This is because full-mesh communication paths exist between leaf switches belonging to different groups. Because of the full-mesh communication paths, for example, data transmission paths from Group b to Group c do not share links with data transmission paths from Group c to Group d. This holds true when the servers assigned the representative processes belong to different layers.

Next described are functions of severs and a job scheduler.

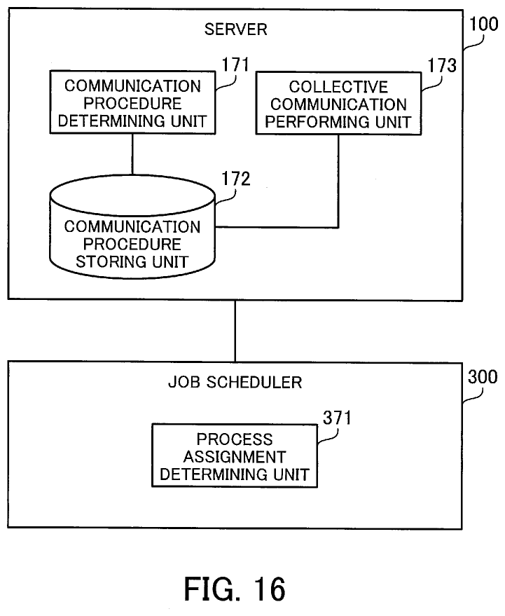

FIG. 16 illustrates exemplary functional components of a server and a job scheduler.

The server 100 includes a communication procedure determining unit 171, a communication procedure storing unit 172, and a collective communication performing unit 173. The communication procedure storing unit 172 is implemented using a storage area secured, for example, in the RAM 152 or the HDD 153. The communication procedure determining unit 171 and the collective communication performing unit 173 are implemented, for example, using programs executed by the CPU 151. Note that other servers also individually have the same modules as those found in the server 100.

The communication procedure determining unit 171 receives, from the job scheduler 300, process assignment information regarding assignment of a plurality of processes belonging to a job. The process assignment information simply needs to be sufficient to allow the communication procedure determining unit 171 to understand mappings between groups and the processes and the location of a process assigned to the server 100 on a two tree. Information needed to be included in the process assignment information also depends on to what extent the communication procedure determining unit 171 and the job scheduler 300 have preliminarily agreed to a process assignment algorithm.

For example, the process assignment information may include information mapping ranks of the processes to node identifiers of servers assigned the processes. In addition, the process assignment information may include the number of groups to be used for the job, the number of processes for each group, the total number of processes and the like. Further, the process assignment information may include an offset of the rank given to the process assigned to the server 100, within a group to which the process belongs.

Based on the received process assignment information, the communication procedure determining unit 171 determines a communication procedure among the multiple processes in collective communication. The procedure of a reduce operation and that of a broadcast operation are inverse from each other, and an allreduce operation is a combination of reduce and broadcast operations. Therefore, the procedure of either one of reduce and broadcast operations needs to be determined. In the second embodiment, the communication procedure determining unit 171 determines the procedure of a reduce operation. The communication procedure determining unit 171 generates communication procedure information representing the determined communication procedure and then stores it in the communication procedure storing unit 172.

The collective communication procedure is determined at the time of initialization of a communication library, such as MPI. User programs using the communication library are located in a plurality of servers, and when they are run on the servers, the communication library is initialized. At the initialization, communication may be performed between the servers. At least part of the process assignment information may be collected via interserver communication, instead of receiving it from the job scheduler 300. In addition, the collective communication procedure may be determined when a request for collective communication is first made from the user program, instead of when the communication library is initialized.

The communication procedure determined here has the rank-0 process as a base point. In the case where a particular process with a rank other than 0 needs results of a reduce operation, data may be obtained from the rank-0 process. In the case of broadcasting data of a process with a rank other than 0, the data may be sent to the rank-0 process. Note however that it is also possible to determine the collective communication procedure using a process with a rank other than 0 as a base point. In addition, the communication procedure information generated by the communication procedure determining unit 171 indicates a communication procedure among all the processes included in the job. Using the same process assignment information and the same collective communication algorithm, the servers generate the same communication procedure information. Note however that the communication procedure information generated may be simplified to indicate only a communication procedure of the server 100.

The communication procedure storing unit 172 stores therein the communication procedure information generated by the communication procedure determining unit 171. The communication procedure information indicates, for each phase of the collective communication, the rank of a destination process to which data is transmitted and the rank of a source process from which data is received.

When the user program invokes a command to start collective communication, the collective communication performing unit 173 performs collective communication based on the communication procedure information stored in the communication procedure storing unit 172. The collective communication performing unit 173 carries out one by one a plurality of phases indicated by the communication procedure information. In the case where a source process is designated for a phase, the collective communication performing unit 173 receives data from the source process. In the case where a destination process is designated for a phase, the collective communication performing unit 173 copies data and transmits the copy to the destination process. In the case of performing collective communication in a pipelined fashion, the collective communication performing unit 173 repeats a plurality of phases (e.g. color-0 and color-1 phases) alternately until transfer of all blocks is completed.

In data transmission, the collective communication performing unit 173 generates packets including the address of a server assigned a destination process and data itself and then outputs the packets to the leaf switch 200 via the HCA 157. The address of a server assigned each process is obtained at the time of initialization of the communication library.

In the second embodiment, collective communication is performed according to a two-tree algorithm. Therefore, the collective communication performing unit 173 manages a data set by splitting it into two. The two subsets are preferably as equally sized as possible. If the data set includes a plurality of records, the records are split into two. In the case of performing the collective communication in a pipelined fashion, each of the two subsets corresponding to two subtrees is further divided into a plurality of blocks. The collective communication performing unit 173 may assign a block number to each block to thereby manage the multiple blocks.

In the case of a reduce operation, the collective communication performing unit 173 receives data from at most one server and transmits data to at most one server in each phase during the intragroup and intergroup communication. Data consolidated and gathered according to one of the subtrees corresponds to the first half of the data set while data consolidated and gathered according to the other subtree corresponds to the second half of the data set. In the case of a broadcast operation, the collective communication performing unit 173 receives data from at most one server and transmits data to at most one server in each phase during the intragroup and intergroup communication. Data copied according to one of the subtrees corresponds to the first half of the data set while data copied according to the other subtree corresponds to the second half of the data set.

The job scheduler 300 includes a process assignment determining unit 371. The process assignment determining unit 371 is implemented, for example, using a program executed by a CPU.

The process assignment determining unit 371 receives a job request from the user and determines assignment of a plurality of processes included in a job in response to the received job request. The number of processes to be run is designated by the job request from the user. In the second embodiment, the process assignment determining unit 371 determines assignment of the processes such that the multiple processes belonging to the same job are assigned as equally as possible to two or more groups. The process assignment determining unit 371 transmits process assignment information regarding the determined process assignment to servers used for the job.

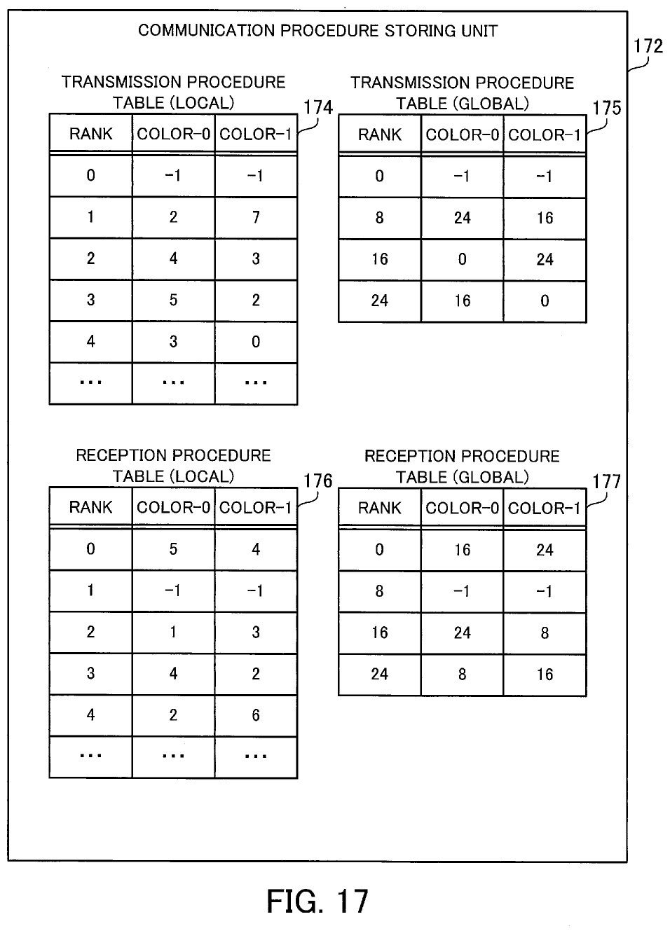

FIG. 17 illustrates exemplary communication procedure tables.

Transmission procedure tables 174 and 175 and reception procedure tables 176 and 177 are generated by the communication procedure determining unit 171 and then stored in the communication procedure storing unit 172. The transmission procedure table 174 and the reception procedure table 176 describe a procedure of the reduce operation based on local two trees. The transmission procedure table 175 and the reception procedure table 177 describe a procedure of a reduce operation based on a global two tree.

The transmission procedure table 174 includes mapping information that associates each of a plurality of ranks with a rank of a destination process to which a process with the associated rank transmits data in a color-0 phase and a rank of a destination process to which the process with the associated rank transmits data in a color-1 phase. Note that if no destination process exists, that is, if the process with the associated rank does not perform data transmission, a predetermined numerical value (e.g. −1) not used for ranks is registered. As one example in FIG. 17, the transmission procedure table 174 includes an entry indicating that the rank-1 process transmits data to the rank-2 process in a color-0 phase and to the rank-7 process in a color-1 phase. Note however that if there is no data to be transmitted, no data communication actually takes place.

The transmission procedure table 175 includes mapping information that associates each rank of a plurality of representative processes with a rank of a destination process in a color-0 phase and a rank of a destination process in a color-1 phase. As one example in FIG. 17, the transmission procedure table 175 includes an entry indicating that the rank-8 process transmits data to the rank-24 process in a color-0 phase and to the rank-16 process in a color-1 phase. Whereas the transmission procedure table 174 represents intragroup communication, the transmission procedure table 175 represents intergroup communication.

The reception procedure table 176 includes mapping information that associates each of the multiple ranks with a rank of a source process from which a process with the associated rank receives data in a color-0 phase and a rank of a source process from which the process with the associated rank receives data in a color-1 phase. Note that if no source process exists, that is, if the process with the associated rank does not perform data reception, a predetermined numerical value (e.g. −1) not used for ranks is registered. As one example in FIG. 17, the reception procedure table 176 includes an entry indicating that the rank-0 process receives data from the rank-5 process in a color-0 phase and from the rank-4 process in a color-1 phase. Note however that if there is no data to be received, no data communication actually takes place.

The reception procedure table 177 includes mapping information that associates each rank of the multiple representative processes with a rank of a source process in a color-0 phase and a rank of a source process in a color-1 phase. As one example in FIG. 17, the reception procedure table 177 includes an entry indicating that the rank-0 process receives data from the rank-16 process in a color-0 phase and from the rank-24 process in a color-1 phase. Whereas the reception procedure table 176 represents intragroup communication, the reception procedure table 177 represents intergroup communication.

In the case of performing a reduce operation, each server controls data transmission by reading a rank of its communication peer from the transmission procedure table 174, and controls data reception by reading a rank of its communication peer from the reception procedure table 176. Then, each server with the assigned process whose rank is registered in the transmission procedure table 175 and the reception procedure table 177 controls data transmission by reading a rank of its communication peer from the transmission procedure table 175, and controls data reception by reading a rank of its communication peer from the reception procedure table 177. In the case of performing the reduce operation in a pipelined fashion, each server repeats color-0 and color-1 phases alternately. For example, a color-0 phase is performed first, or alternatively a color-1 phase may be performed first.

In the case of performing a broadcast operation, the roles of transmission and reception are swapped from those designated in a reduce operation. Therefore, the destination processes in the transmission procedure tables 174 and 175 are interpreted as source processes for the broadcast operation while the source processes in the reception procedure tables 176 and 177 are interpreted as destination processes for the broadcast operation.

Therefore, each server with the assigned process whose rank is registered in the transmission procedure table 175 and the reception procedure table 177 controls data transmission by reading a rank of its communication peer from the reception procedure table 177, and controls data reception by reading a rank of its communication peer from the transmission procedure table 175. Then, each server controls data transmission by reading a rank of its communication peer from the reception procedure table 176, and controls data reception by reading a rank of its communication peer from the transmission procedure table 174. In the case of performing the broadcast operation in a pipelined fashion, each server repeats color-0 and color-1 phases alternately. For example, a color-0 phase is performed first, or alternatively a color-1 phase may be performed first.

Next described is a processing procedure of the server 100.

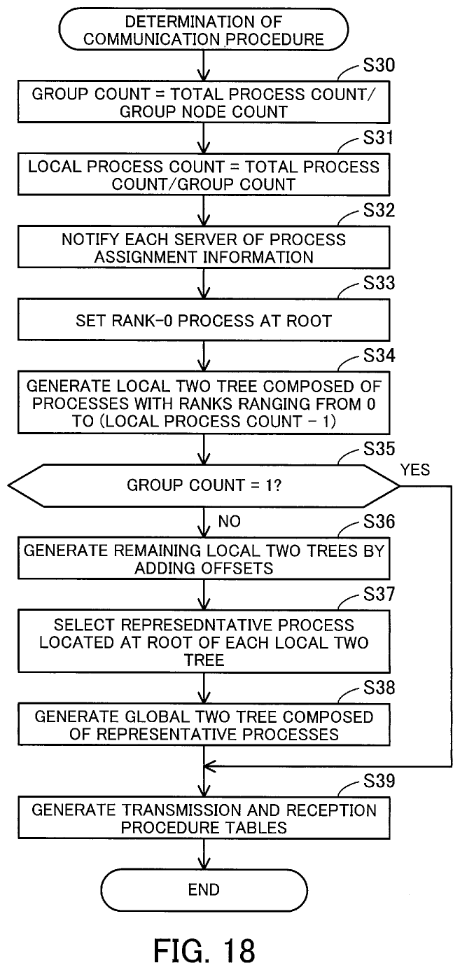

FIG. 18 is a flowchart illustrating an exemplary process for determining a communication procedure.

(Step S30) The process assignment determining unit 371 determines the number of groups to be used for a job concerned. Specifically, the process assignment determining unit 371 divides the number of processes included in the job (the total process count) by the number of servers included in each of Groups a, b, c, and d (the group node count) to thereby calculate the number of groups to be used (the group count). The calculated result here is rounded up to the next whole number. For example, because the group node count is 9 according to the second embodiment, if the total process count is 32, the group count is calculated as: 32+9=4.

(Step S31) The process assignment determining unit 371 calculates the number of processes assigned to each group (the local process count) by dividing the total process count by the group count calculated in step S30. For example, when the total process count is 32, the local process count is calculated as: 32+4=8.

The process assignment determining unit 371 assigns, to each of the groups, the number of which is calculated in step S30, as many processes as the local process count such that ranks are arranged in a sequential order within the group. For example, ranks of 0, 1, 2, 3, 4, 5, 6, and 7 are assigned to Group a; ranks of 8, 9, 10, 11, 12, 13, 14, and 15 are assigned to Group b; ranks of 16, 17, 18, 19, 20, 21, 22, and 23 are assigned to Group c; and ranks of 24, 25, 26, 27, 28, 29, 30, and 31 are assigned to Group d.

(Step S32) The process assignment determining unit 371 notifies each server, to which a process is assigned, of process assignment information regarding the determined process assignment. Note that the process assignment information may include, for example, the group count, the local process count, and the total process count. In addition, if each server and the job scheduler 300 have preliminarily agreed to a process assignment algorithm, steps S30 and S31 may be performed by the server 100.

(Step S33) The communication procedure determining unit 171 sets the rank-0 process as the root of an entire tree.

(Step S34) The communication procedure determining unit 171 generates a local two tree using processes whose ranks ranging from 0 to a number one less than the local process count. Specifically, the communication procedure determining unit 171 forms the left subtree by generating a binary tree composed of the processes with the ranks ranging from 1 to the number one less than the local process count, where the in-order traversal visits these processes in the ascending order of their rank numbers. The communication procedure determining unit 171 generates the right subtree by cyclic shifting each rank in the left subtree to the next one. The communication procedure determining unit 171 connects the left and right subtrees to the rank-0 process to thereby form a local two tree. Herewith, for example, the first local two tree of FIG. 14 is generated.

(Step S35) The communication procedure determining unit 171 determines whether the group count is 1, that is, whether all the processes included in the job are closed into a single group. If the group count is 1, the process moves to step S39. On the other hand, if the group count is 2 or more, the process moves to step S36. Note that when the group count is 1, a global two tree is not generated.

(Step S36) The communication procedure determining unit 171 adds predetermined offsets to each rank of the local two tree generated in step S34 to thereby generate local two trees of the remaining groups. The offsets are the integral multiples of the local process count. In the example of FIG. 14, the second local two tree is generated by adding 8 to the individual ranks of the first local two tree. The third local two tree is generated by adding 16 to the individual ranks of the first local two tree. The third local two tree is generated by adding 24 to the individual ranks of the first local two tree.

(Step 637) The communication procedure determining unit 171 selects, as a representative process, a process located at the root of each of the local two trees generated in steps S34 and S36.

(Step S38) The communication procedure determining unit 171 generates a global two tree of the multiple representative processes selected in step S37. Specifically, the communication procedure determining unit 171 forms the left subtree by generating a binary tree composed of the multiple representative processes, where the in-order traversal visits the representative processes in the ascending order of their rank numbers. The communication procedure determining unit 171 generates the right subtree by cyclic shifting each rank in the left subtree to the next one. In the cyclic shifting, the rank of each process, other than the process with the highest rank, is changed to the next higher rank in the ranks of the representative processes. The process with the highest rank is changed to, in the ranks of the representative processes, the next lowest rank after a rank of 0. The communication procedure determining unit 171 connects the left and right subtrees to the rank-0 process to thereby form a global two tree. Herewith, for example, the global two tree of FIG. 15 is generated.

(Step S39) The communication procedure determining unit 171 determines a procedure for an intragroup reduce operation according to the local two trees generated in steps S34 and S36. In addition, if a global two tree has been generated, the communication procedure determining unit 171 determines a procedure for an intergroup reduce operation according to the global two tree generated in step S38. The communication procedure determining unit 171 generates, based on the determined communication procedures, the transmission procedure tables 174 and 175 and the reception procedure tables 176 and 177 and then stores them in the communication procedure storing unit 172.

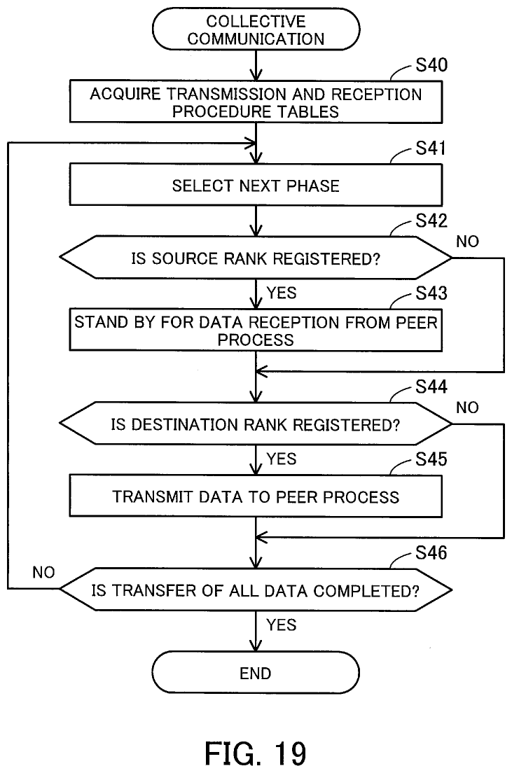

FIG. 19 is a flowchart illustrating an exemplary process for collective communication.

(Step S40) Upon receiving a request for collective communication from a user program, the collective communication performing unit 173 acquires the transmission procedure tables 174 and 175 and the reception procedure tables 176 and 177. The request for collective communication from the user program is a request for a reduce operation, a broadcast operation, or an allreduce operation.

(Step S41) The collective communication performing unit 173 selects the next phase. For example, the collective communication performing unit 173 alternately selects the color-0 phase and the color-1 phase. For example, the color-0 phase is selected first.

(Step S42) For data reception, the collective communication performing unit 173 reads a numerical value corresponding to a combination of the phase selected in step S41 and the rank of a process assigned to the server 100. In the case of a reduce operation, the collective communication performing unit 173 first reads a numerical value from the reception procedure table 176, and then reads a numerical value from the reception procedure table 177 after the completion of intragroup communication. In the case of a broadcast operation, the collective communication performing unit 173 first reads a numerical value from the transmission procedure table 175, and then reads a numerical value from the transmission procedure table 174 after the completion of intergroup communication. The collective communication performing unit 173 determines whether the read value represents a source rank, that is, whether an appropriate source rank is registered. The read value being “−1” means that no source rank is registered. If a source rank is registered, the process moves to step S43. If not, the process moves to step S44.

(Step S43) The collective communication performing unit 173 stands by for receiving data from a peer process indicated by the source rank and receives the data. For example, the collective communication performing unit 173 periodically checks a receive buffer corresponding to the peer process, and retrieves data from the receive buffer if the data has arrived. The data reception may be performed in parallel with steps S44 and S45 and only needs to be performed by no later than step S46. The collective communication performing unit 173 retains the received data.

(Step S44) For data transmission, the collective communication performing unit 173 reads a numerical value corresponding to a combination of the phase selected in step S41 and the rank of a process assigned to the server 100. In the case of a reduce operation, the collective communication performing unit 173 first reads a numerical value from the transmission procedure table 174, and then reads a numerical value from the transmission procedure table 175 after the completion of intragroup communication. In the case of a broadcast operation, the collective communication performing unit 173 first reads a numerical value from the reception procedure table 177, and then reads a numerical value from the reception procedure table 176 after the completion of intergroup communication. The collective communication performing unit 173 determines whether the read value represents a destination rank, that is, whether an appropriate destination rank is registered. The read value being “−1” means that no destination rank is registered. If a destination rank is registered, the process moves to step S45. If not, the process moves to step S46.

(Step S45) The collective communication performing unit 173 transmits data to a peer process indicated by the destination rank. The transmission data is divided into packets, each of which is given an address of a server assigned the peer process. The address may also serve as a node identifier. A data set is managed by splitting it into two subsets, one corresponding to the left subtree and the other to the right subtree. In the case of performing the collective communication in a pipelined fashion, each of the two subsets is managed by dividing it into a plurality of blocks. Data to be transmitted may include data generated by the server 100 and may include data received from a different server.

(Step S46) The collective communication performing unit 173 determines whether transfer of all data to be transferred by the server 100 is completed. If transfer of all the data is completed, the collective communication ends. On the other hand, if there is data yet to be transferred, the process moves to step S41.

Note that, according to the second embodiment, each group is formed of a plurality of leaf switches connected to the same set of spine switches and servers subordinate to the multiple leaf switches. Alternatively, each group may be formed of one leaf switch and servers subordinate to the single leaf switch.

In this case, one representative process is selected for each leaf switch. For intergroup communication, a global two tree is composed of the multiple representative processes corresponding to the multiple leaf switches. For intragroup communication, local two trees are generated, each composed of a plurality of processes subordinate to a leaf switch. For example, in the multi-layer full mesh system of FIGS. 2 and 3, twelve groups are formed. Grouping servers in this way does not cause communication conflicts in the intergroup communication between the multiple leaf switches. In addition, no communication conflicts occur in the intragroup communication under each leaf switch.

According to the second embodiment, the collective communication is carried out in two stages; however, it may be performed in three stages by hierarchizing groups. Each major group is formed of a plurality of leaf switches connected to the same set of spine switches and servers subordinate to the multiple leaf switches. In addition, each minor group is formed of one leaf switch and servers subordinate to the single leaf switch.

In this case, a higher-level representative process is selected for each major group, and further, a lower-level representative process is selected for each leaf switch. As a first level, a higher-level global two tree is composed of a plurality of higher-level representative processes corresponding to the multiple major groups. As a second level, a lower-level global two tree is composed of a plurality of lower-level representative processes corresponding to the multiple leaf switches. As a third level, a local two tree is composed of a plurality of processes subordinate to each leaf switch. For example, in the multi-layer full mesh system of FIGS. 2 and 3, four major groups and twelve minor groups are formed. When there are a large number of servers, this leaf switch-based grouping proves useful.

The multi-layer full mesh system according to the second embodiment adopts a multi-layer full mesh topology, in which redundancy of higher-level communication devices is provided and redundancy in communication paths between lower-level communication devices is established. This relieves traffic congestion. When compared to a simple fat tree topology, the multi-layer full mesh topology enables a reduction in the number of communication devices, which results in reduced cost of system building. In addition, the multi-layer full mesh system of the second embodiment carries out collective communication according to a two tree such that unused communication band of links is reduced. This allows fast collective communication.

In addition, a plurality of leaf switches connected to the same set of spine switches and nodes subordinate to the multiple leaf switches are put into the same group, and a representative node is selected from each group. Then, collective communication is carried out in two stages, data transmission between the representative nodes and intragroup data transmission with each representative node as a base point. Because there is a full mesh of communication paths between the groups, no communication conflicts occur when the multiple nodes perform parallel communication if one node per group participates in the communication. In addition, the intragroup network topology corresponds to a fat tree. Therefore, under the condition of closed communication between nodes within each group, communication conflicts are avoided even when a plurality of nodes performs parallel communication. Taking control of communication conflicts results in control of communication delay, thereby shortening the time needed for the collective communication.

According to one aspect, it is possible to control communication conflicts in internode communication.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. A non-transitory computer-readable recording medium storing therein a computer program that causes a computer to execute a process comprising:
classifying, in a system including a plurality of nodes, a plurality of first relay devices, and a plurality of second relay devices, where each of the plurality of nodes is connected to one of the plurality of first relay devices and each of the plurality of first relay devices is connected to two or more second relay devices from among the plurality of second relay devices, the plurality of nodes into a plurality of groups such that different nodes individually connected to different first relay devices having different sets of the two or more second relay devices connected thereto are classified into different groups;
selecting a representative node from each of the plurality of groups;
determining communication order of first internode communication performed between the representative nodes corresponding to the plurality of groups such that, with one of the representative nodes serving as a base point, a first transfer process is performed, where remaining representative nodes other than the one of the representative nodes transfer data according to a first tree, in parallel with which a second transfer process is performed, where the remaining representative nodes transfer, according to a second tree, data different from the data transferred in the first transfer process; and
determining, with respect to each of the plurality of groups, communication order of second internode communication performed between two or more nodes included in the each of the plurality of groups before or after the first internode communication such that, with the representative node of the each of the plurality of groups serving as a base point, a third transfer process is performed, where remaining nodes other than the representative node transfer data according to a third tree, in parallel with which a fourth transfer process is performed, where the remaining nodes transfer, according to a fourth tree, data different from the data transferred in the third transfer process.

2. The non-transitory computer-readable recording medium according to claim 1, wherein the classifying includes classifying, into a same group, different nodes individually connected to different first relay devices having a same set of the two or more second relay devices connected thereto.

3. The non-transitory computer-readable recording medium according to claim 1, wherein the representative node of the each of the plurality of groups is, among the two or more nodes included in the each of the plurality of groups, a node assigned a process having a lowest identification number.

4. The non-transitory computer-readable recording medium according to claim 1, wherein:
the first internode communication is performed after the second internode communication,
in the third transfer process, a part of data stored in the remaining nodes is transferred to the representative node of the each of the plurality of groups, and in the fourth transfer process, another part of the data stored in the remaining nodes is transferred to the representative node of the each of the plurality of groups, and
in the first transfer process, a part of data consolidated and gathered in the remaining representative nodes is transferred to the one of the representative nodes, and in the second transfer process, another part of the data consolidated and gathered in the remaining representative nodes is transferred to the one of the representative nodes.

5. The non-transitory computer-readable recording medium according to claim 1, wherein:
the determining of the communication order of the first internode communication includes generating the second tree by cyclic shifting, in the first tree, a position of each of the remaining representative nodes, and
the determining of the communication order of the second internode communication includes generating the fourth tree by cyclic shifting, in the third tree, a position of each of the remaining nodes.

6. A communication control method comprising:
classifying, by a processor, in a system including a plurality of nodes, a plurality of first relay devices, and a plurality of second relay devices, where each of the plurality of nodes is connected to one of the plurality of first relay devices and each of the plurality of first relay devices is connected to two or more second relay devices from among the plurality of second relay devices, the plurality of nodes into a plurality of groups such that different nodes individually connected to different first relay devices having different sets of the two or more second relay devices connected thereto are classified into different groups;
selecting, by the processor, a representative node from each of the plurality of groups;
determining, by the processor, communication order of first internode communication performed between the representative nodes corresponding to the plurality of groups such that, with one of the representative nodes serving as a base point, a first transfer process is performed, where remaining representative nodes other than the one of the representative nodes transfer data according to a first tree, in parallel with which a second transfer process is performed, where the remaining representative nodes transfer, according to a second tree, data different from the data transferred in the first transfer process; and
determining, by the processor, with respect to each of the plurality of groups, communication order of second internode communication performed between two or more nodes included in the each of the plurality of groups before or after the first internode communication such that, with the representative node of the each of the plurality of groups serving as a base point, a third transfer process is performed, where remaining nodes other than the representative node transfer data according to a third tree, in parallel with which a fourth transfer process is performed, where the remaining nodes transfer, according to a fourth tree, data different from the data transferred in the third transfer process.

7. An information processing apparatus comprising:
a memory configured to store, in a system including a plurality of nodes, a plurality of first relay devices, and a plurality of second relay devices, where each of the plurality of nodes is connected to one of the plurality of first relay devices and each of the plurality of first relay devices is connected to two or more second relay devices from among the plurality of second relay devices, communication control data indicating communication order of internode communication between the plurality of nodes; and
a processor configured to determine the communication order of the internode communication,
wherein the processor executes a process including:
classifying the plurality of nodes into a plurality of groups such that different nodes individually connected to different first relay devices having different sets of the two or more second relay devices connected thereto are classified into different groups,
selecting a representative node from each of the plurality of groups,
determining communication order of first internode communication performed between the representative nodes corresponding to the plurality of groups such that, with one of the representative nodes serving as a base point, a first transfer process is performed, where remaining representative nodes other than the one of the representative nodes transfer data according to a first tree, in parallel with which a second transfer process is performed, where the remaining representative nodes transfer, according to a second tree, data different from the data transferred in the first transfer process, and
determining, with respect to each of the plurality of groups, communication order of second internode communication performed between two or more nodes included in the each of the plurality of groups before or after the first internode communication such that, with the representative node of the each of the plurality of groups serving as a base point, a third transfer process is performed, where remaining nodes other than the representative node transfer data according to a third tree, in parallel with which a fourth transfer process is performed, where the remaining nodes transfer, according to a fourth tree, data different from the data transferred in the third transfer process.
